(19) United States
(12) Patent Application Publication
(10) Pub. No.: US 2012/0285266 A1
(43) Pub. Date: Nov. 15, 2012

(54) TORQUE SENSOR

(75) Inventors: Yoshiki TAKAHASHI, Okazaki-city (JP); Shigetoshi Fukaya, Toyota-city (JP); Osamu Shimomura, Okazaki-city (JP)

(73) Assignees: NIPPON SOKEN, INC., Nishio-city (JP); DENSO CORPORATION, Kariya-city (JP)

(21) Appl. No.: 13/469,145

(22) Filed: May 11, 2012

(30) Foreign Application Priority Data
May 13, 2011 (JP) 2011-108599
May 13, 2011 (JP) 2011-108600

(51) Int. Cl. G01L 3/10

(52) U.S. Cl. 73/862.331

(57) ABSTRACT

Two magnetic flux collecting rings are installed into a corresponding position axially located between two magnetic yokes. The magnetic flux collecting rings collect a magnetic flux from the magnetic yokes. The magnetic flux collecting rings at least partially overlap with the magnetic yokes in a view taken in the axial direction.

### CROSS REFERENCE TO RELATED APPLICATION

This application is based on and incorporates herein by reference Japanese Patent Application No. 2011-108600 filed on May 13, 2011 and Japanese Patent Application No. 2011-108599 filed on May 13, 2011.

### TECHNICAL FIELD

The present disclosure relates to a torque sensor.

### BACKGROUND

A torque sensor, which senses a shaft torque in, for example, an electric power steering apparatus of a vehicle, is known. For example, JP2003-149062A (corresponding to US2002189371A1) teaches a torque sensor, which senses a shaft torque by sensing a magnetic flux generated in two magnetic yokes. The magnetic flux, which is sensed by the torque sensor, is generated in the two magnetic yokes due to a change in a circumferential relative position between a multipolar magnet and the two magnetic yokes upon generation of torsion in a torsion bar that connects between an input shaft and an output shaft.

JP2003-329523A (corresponding to US2003167857A1) teaches two magnetic flux collecting rings, which collect a magnetic flux from two magnetic yokes and are configured into a semicircular shape, i.e., an open semi-ring form to enable installation of the magnetic flux collecting rings in a radial direction, thereby improving the assembling efficiency.

JP2008-216019A teaches a torque sensor, which uses a permanent magnet that is magnetized to have an N-pole at one axial side and an S-pole at the other axial side.

In the torque sensors of JP2003-149062A (corresponding to US2002189371A1) and JP2003-329523A (corresponding to US2003167857A1), the two magnetic flux collecting rings (serving as two magnetic flux collecting bodies) are placed radially outward of the two magnetic yokes such that the magnetic flux collecting rings are opposed to the magnetic yokes only in the radial direction. Therefore, in the case where the two magnetic flux collecting rings are configured into the semicircular shape, a total size of opposed surface areas of the two magnetic flux collecting rings, which are opposed to the two magnetic yokes, is reduced to about one half in comparison to a case where the two magnetic flux collecting rings are configured into a circular shape, thereby resulting in a reduction in the amount of a collectable magnetic flux, which can be magnetically collected by the magnetic flux collecting rings.

In the torque sensor of JP2008-216019A, three members, i.e., a magnet side magnetic body, a magnetic body and an auxiliary magnetic body are placed as magnetic flux conducting members on a radially outer side of the magnet. Specifically, the magnet side magnetic body and the magnetic body correspond to the two magnetic yokes, and the auxiliary magnetic body corresponds to the two magnetic flux collecting bodies. Therefore, the torque sensor of JP2008-216019A has the increased number of the components and an increased radial size. Also, the shape of each component becomes complicated.

Furthermore, in the torque sensors of JP2003-149062A (corresponding to US2002189371A1) and JP2003-329523A (corresponding to US2003167857A1), the two magnetic flux collecting rings (serving as two magnetic flux collecting bodies) are placed radially outward of the two magnetic yokes such that the magnetic flux collecting rings are opposed to the magnetic yokes only in the radial direction. The two magnetic flux collecting rings may be placed between the two magnetic yokes in the axial direction such that the two magnetic flux collecting rings are opposed to the two magnetic yokes in the axial direction. In this way, the amount of a collectable magnetic flux, which can be magnetically collected, is increased.

However, in such a case, when a magnetic sensor, which senses a density of the magnetic flux magnetically collected by the two magnetic flux collecting rings, is placed excessively close to a multipolar magnet, which is located on a radially inner side of the magnetic sensor, the magnetic sensor may be influenced by a periodic change of the magnetic flux caused by a torsional displacement of a torsion bar. Therefore, at the time of rotating the torsion bar in a state where a constant torque is applied to the torsion bar, an output voltage of the magnetic sensor may be periodically changed.

### SUMMARY

The present disclosure addresses the above disadvantages.

According to the present disclosure, there is provided a torque sensor, which includes a torsion bar, a multipolar magnet, first and second magnetic yokes, first and second magnetic flux collecting bodies and a magnetic sensor. The torsion bar coaxially couples between a first shaft and a second shaft and converts a torque exerted between the first shaft and the second shaft into a torsional displacement in the torsion bar. The multipolar magnet is fixed to one of the first shaft and one end portion of the torsion bar. The first and second magnetic yokes are placed radially outward of the multipolar magnet and is fixed to one of the second shaft and the other end portion of the torsion bar, which is opposite from the one end portion of the torsion bar in an axial direction. The first and second magnetic yokes are opposed to each other in the axial direction while a gap is interposed between the first and second magnetic yokes in the axial direction, and the first and second magnetic yokes form a magnetic circuit in a magnetic field generated by the multipolar magnet. Each of the first and second magnetic flux collecting bodies has an opening that opens in a direction perpendicular to the axial direction and is installed into a corresponding position axially located between the first and second magnetic yokes from one radial side of the first and second magnetic yokes. The first and second magnetic flux collecting bodies collect a magnetic flux from the first and second magnetic yokes. The magnetic sensor senses a strength of a magnetic field between the first and second magnetic flux collecting bodies. The first and second magnetic flux collecting bodies at least partially overlap with the first and second magnetic yokes in a view taken in the axial direction.

According to the present disclosure, there is also provided a torque sensor, which includes a torsion bar, a multipolar magnet, first and second magnetic yokes, first and second magnetic flux collecting bodies and a magnetic sensor. The torsion bar coaxially couples between a first shaft and a second shaft and converts a torque exerted between the first shaft and the second shaft into a torsional displacement in the torsion bar. The multipolar magnet is fixed to one of the first shaft and one end portion of the torsion bar. The first and second magnetic yokes are placed radially outward of the multipolar magnet and is fixed to one of the second shaft and the other end portion of the torsion bar, which is opposite from the one end portion of the torsion bar in an axial direction. The first and second magnetic yokes are opposed to each other in the axial direction while a gap is interposed between the first and second magnetic yokes in the axial direction, and the first and second magnetic yokes form a magnetic circuit in a magnetic field generated by the multipolar magnet. The first and second magnetic flux collecting bodies are placed between the first and second magnetic yokes in the axial direction and at least partially overlap with the first and second magnetic yokes in an axial view taken in the axial direction. The first and second magnetic flux collecting bodies collect a magnetic flux from the first and second magnetic yokes. The magnetic sensor senses a strength of a magnetic field between the first and second magnetic flux collecting bodies. Each of the first and second magnetic flux collecting bodies has an inner peripheral edge on a radially inner side thereof where the multipolar magnet is placed. A distance from a central axis of the multipolar magnet to the inner peripheral edge of each of the first and second magnetic flux collecting bodies is set to be maximum in a predetermined radial direction along an imaginary line, which radially connects between the central axis and the magnetic sensor.

### BRIEF DESCRIPTION OF THE DRAWINGS

The drawings described herein are for illustration purposes only and are not intended to limit the scope of the present disclosure in any way.

FIG. 1 is an exploded perspective view of a torque sensor according to a first embodiment of the present disclosure;

FIG. 2 is a schematic diagram showing an electric power steering apparatus, in which the torque sensor of the first embodiment is applied;

FIG. 3A is a plan view of a yoke unit of the first embodiment;

FIG. 3B is a cross-sectional view of the yoke unit shown in FIG. 3A;

FIG. 3C is a cross-sectional view taken along line IIIC-IIIC in FIG. 3A;

FIG. 4A is a plan view of a sensor unit of the first embodiment;

FIG. 4B is a cross-sectional view taken along line IVB-IVB in FIG. 4A;

FIG. 4C is a plan view showing one of two magnetic flux collecting rings of the first embodiment;

FIG. 4D is a side view showing the two magnetic flux collecting rings of the first embodiment;

FIG. 5A is a schematic view of the torque sensor in one operational state for describing an operational principle of a torque sensor according to the first embodiment;

FIG. 5B is a cross-sectional view taken along line VB-VB in FIG. 5A;

FIG. 6A is a schematic view of the torque sensor in another operational state for describing the operational principle of the torque sensor according to the first embodiment;

FIG. 6B is a cross-sectional view taken along line VIB-VIB in FIG. 6A;

FIG. 7A is a plan view showing one of two magnetic flux collecting rings according to a second embodiment of the present disclosure;

FIG. 7B is a side view showing the two magnetic flux collecting rings of the second embodiment;

FIG. 7C is a side view showing the one of the two magnetic flux collecting rings shown in FIG. 7A;

FIG. 7D is a plan view showing one of two magnetic flux collecting rings according to a third embodiment of the present disclosure;

FIG. 7E is a side view showing the two magnetic flux collecting rings of the third embodiment;

FIG. 7F is a plan view showing one of two magnetic flux collecting rings according to a fourth embodiment of the present disclosure;

FIG. 7G is a side view showing the two magnetic flux collecting rings of the fourth embodiment;

FIG. 8A is a plan view showing one of two magnetic flux collecting rings according to a fifth embodiment of the present disclosure;

FIG. 8B is a side view showing the two magnetic flux collecting rings of the fifth embodiment;

FIG. 8C is a plan view showing one of two magnetic flux collecting rings according to a sixth embodiment of the present disclosure;

FIG. 8D is a side view showing the two magnetic flux collecting rings of the sixth embodiment;

FIG. 8E is a plan view showing one of two magnetic flux collecting rings according to a seventh embodiment of the present disclosure;

FIG. 8F is a side view showing the two magnetic flux collecting rings of the seventh embodiment;

FIGS. 9A is a partial side view showing a magnetic flux collecting portion of one of the magnetic flux collecting rings of the first embodiment;

FIGS. 9B to 9D are partial side views showing various modifications of the magnetic flux collecting portion of FIG. 9A;

FIG. 10A is a partial side view showing the magnetic flux collecting rings of the first embodiment;

FIG. 10B is a modification of the magnetic flux collecting rings of FIG. 10A;

FIG. 11A is a plan view of a sensor unit of an eighth embodiment of the present disclosure;

FIG. 11B is a cross-sectional view taken along line XIB-XIB in FIG. 11A;

FIG. 11C is a plan view showing one of two magnetic flux collecting rings of the eighth embodiment;

FIG. 11D is a side view showing the two magnetic flux collecting rings of the eighth embodiment;

FIG. 12A is a schematic view of the torque sensor in one operational state for describing an operational principle of a torque sensor according to the eighth embodiment;

FIG. 12B is a cross-sectional view taken along line XIIB-XIIB in FIG. 12A;

FIG. 13A is a schematic view of the torque sensor in another operational state for describing the operational principle of the torque sensor according to the eighth embodiment;

FIG. 13B is a cross-sectional view taken along line XIIIB-XIIIB in FIG. 13A;

FIG. 14A is a plan view showing one of two magnetic flux collecting rings according to a ninth embodiment of the present disclosure;

FIG. 14B is a side view showing the two magnetic flux collecting rings of the ninth embodiment;

FIG. 14C is a side view showing the one of the two magnetic flux collecting rings shown in FIG. 14A;

FIG. 14D is a plan view showing one of two magnetic flux collecting rings according to a tenth embodiment of the present disclosure;

FIG. 14E is a side view showing the two magnetic flux collecting rings of the tenth embodiment;

FIG. 14F is a plan view showing one of two magnetic flux collecting rings according to an eleventh embodiment of the present disclosure;

FIG. 14G is a side view showing the two magnetic flux collecting rings of the eleventh embodiment;

FIG. 15A is a plan view showing one of two magnetic flux collecting rings according to a twelfth embodiment of the present disclosure;

FIG. 15B is a side view showing the two magnetic flux collecting rings of the twelfth embodiment;

FIG. 15C is a plan view showing one of two magnetic flux collecting rings according to a thirteenth embodiment of the present disclosure;

FIG. 15D is a side view showing the two magnetic flux collecting rings of the thirteenth embodiment;

FIG. 16A is a plan view showing one of two magnetic flux collecting rings in a modification of the eighth embodiment;

FIG. 16B is a side view showing the two magnetic flux collecting rings of FIG. 16A;

FIG. 16C is a plan view showing one of two magnetic flux collecting rings in another modification of the eighth embodiment;

FIG. 16D is a side view showing the two magnetic flux collecting rings of FIG. 16C;

FIG. 16E is a plan view showing one of two magnetic flux collecting rings in another modification of the eighth embodiment;

FIG. 16F is a side view showing the two magnetic flux collecting rings of FIG. 16E;

FIG. 17A is a plan view showing one of two magnetic flux collecting rings in another modification of the eighth embodiment;

FIG. 17B is a plan view showing one of two magnetic flux collecting rings in another modification of the eighth embodiment;

FIG. 18A is a plan view showing one of two magnetic flux collecting rings in another modification of the eighth embodiment;

FIG. 18B is a plan view showing one of two magnetic flux collecting rings in another modification of the eighth embodiment;

FIG. 18C is a plan view showing one of two magnetic flux collecting rings in another modification of the eighth embodiment;

FIG. 19 is an exploded perspective view of a torque sensor of a prior art;

FIG. 20A is a schematic view of the torque sensor of the prior art shown in FIG. 19; and

FIG. 20B is an enlarged cross-sectional view taken along line XXB-XXB in FIG. 20A.

### DETAILED DESCRIPTION

Various embodiments of the present disclosure will be described with reference to the accompanying drawings.

### First Embodiment

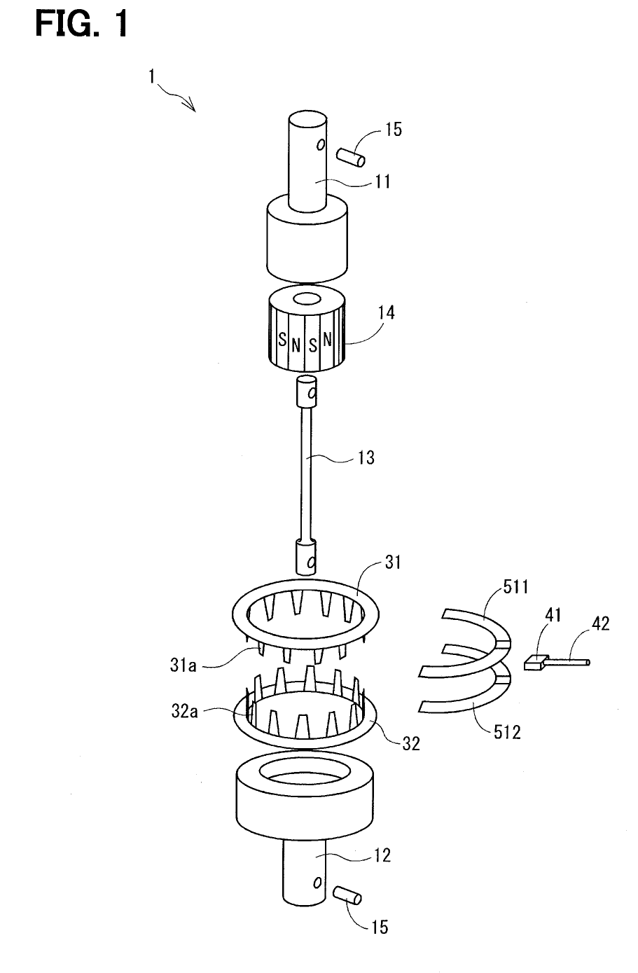

With reference to FIG. 1, a torque sensor 1 of the first embodiment of the present disclosure is applied to an electric power steering apparatus, which assists a steering operation of a vehicle.

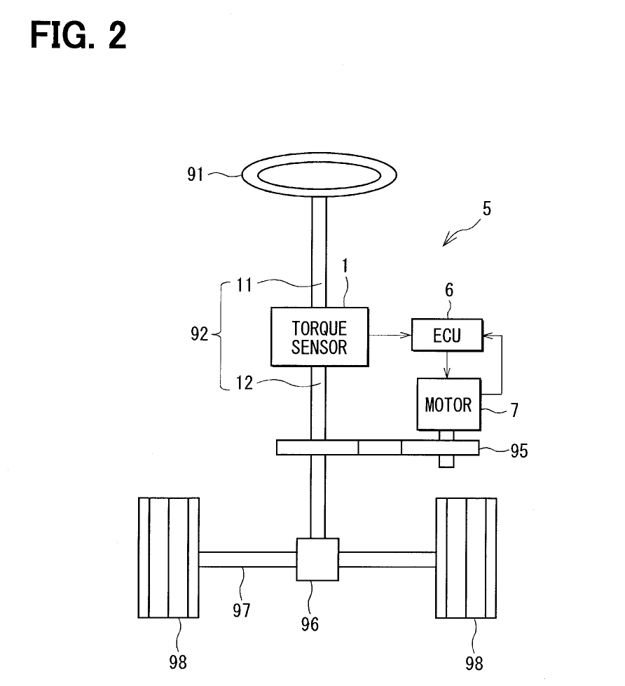

FIG. 2 is a schematic diagram showing an entire structure of a steering system, which includes the electric power steering apparatus 5. The torque sensor 1, which senses a steering torque, is provided at a steering shaft 92, which is connected to a handle (a steering wheel) 91. A pinion gear 96 is provided at a distal end portion of the steering shaft 92 and is meshed with a rack shaft 97. Two drive wheels 98 are rotatably connected to two opposed end portions, respectively, of the rack shaft 97 through, for example, a tie rod. Rotational motion of the steering shaft 92 is converted into linear motion of the rack shaft 97 through the pinion gear 96 to steer the wheels 98.

The torque sensor 1 is placed between an input shaft 11 and an output shaft 12 of the steering shaft 92. The torque sensor 1 senses the steering torque, which is applied to the steering shaft 92. Then, the torque sensor 1 outputs the sensed steering torque to an electronic control unit (ECU) 6. The ECU 6 controls an output of an electric motor 7 based on the sensed steering torque. A steering assist torque, which is generated by the electric motor 7, is conducted to a speed reducing gear 95, at which a rotational speed of the rotation outputted from the electric motor 7 is reduced, and the steering assist torque is then transmitted to the steering shaft 92.

Next, the structure of the torque sensor 1 will be described with reference to FIGS. 1 and 3A to 4D.

As shown in FIG. 1, the torque sensor 1 includes a torsion bar 13, a multipolar magnet 14, two magnetic yokes (serving as first and second magnetic yokes) 31, 32, two magnetic flux collecting rings (serving as first and second magnetic flux collecting bodies) 511, 512 and a magnetic sensor 41.

One end portion of the torsion bar 13 is fixed to the input shaft (serving as a first shaft) 11 through a fixation pin 15, and the other end portion of the torsion bar 13, which is opposite from the one end portion in the axial direction, is fixed to the output shaft (serving as a second shaft) 12 through a fixation pin 15. Therefore, the torsion bar 13 coaxially couples between the input shaft 11 and the output shaft 12. The torsion bar 13 is a resilient member, which is configured into a rod form. The torsion bar 13 converts the steering torque, which is exerted between the input shaft 11 and the output shaft 12 of the steering shaft 92, into torsional displacement in the torsion bar 13.

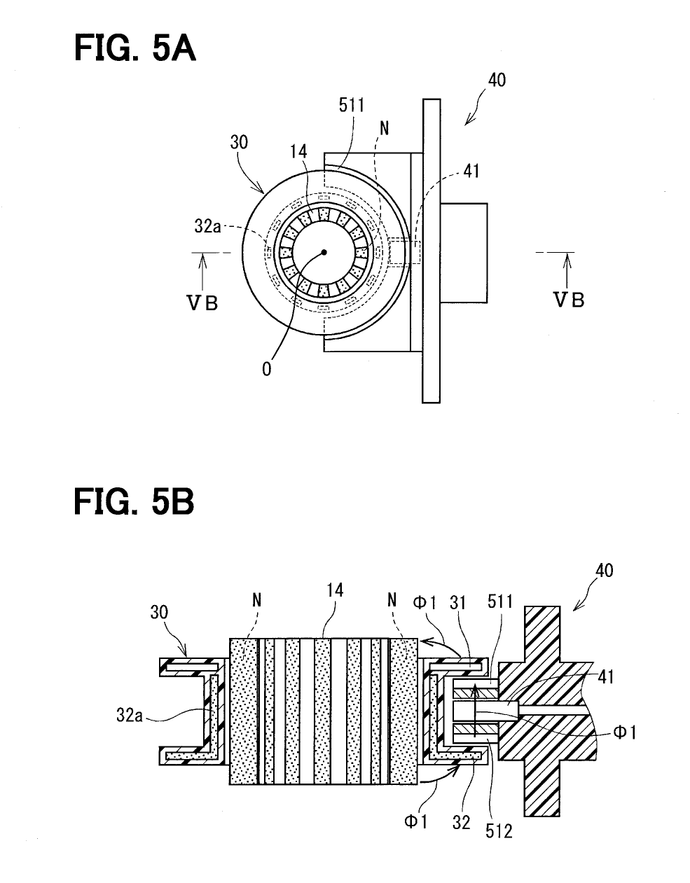

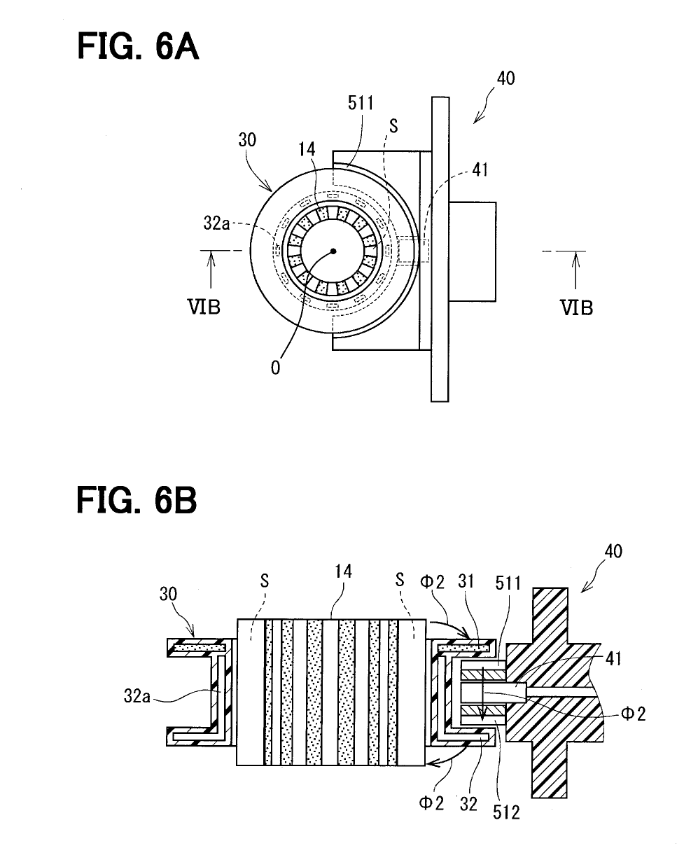

The multipolar magnet 14, which is configured into a cylindrical tubular form, is magnetized to have a plurality of N-poles and a plurality of S-poles, which are alternately arranged one after another in the circumferential direction. For instance, in this embodiment, the number of the N-poles is twelve, and the number of the S-pole is also twelve, so that the multipolar magnet 14 has twenty four magnetic poles (see FIGS. 5A to 6B). However, the number of the magnetic poles of the multipolar magnet is not limited to twenty four and may be changed to any other appropriate even number.

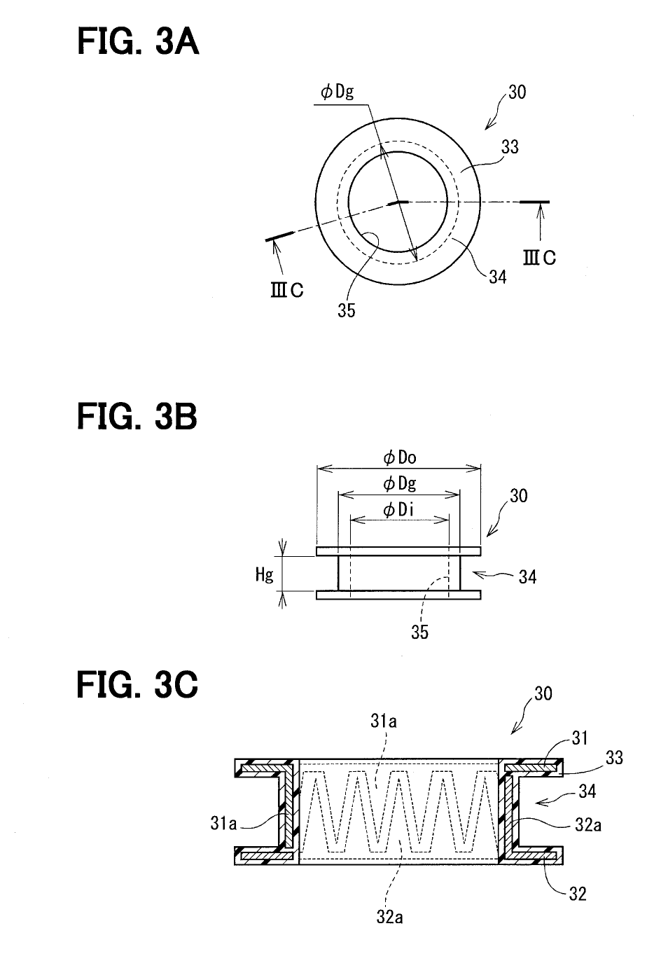

Each of the magnetic yokes 31, 32 is made of a soft magnetic material and is configured into a ring form (ring shape). The magnetic yokes 31, 32 are fixed to the output shaft 12 at a location that is radially outward of the multipolar magnet 14. Each of the magnetic yokes 31, 32 has a plurality of claws (teeth) 31a, 32a, which are arranged one after another at generally equal intervals along an inner peripheral edge of a ring portion of the magnetic yoke 31, 32. The number (twelve in this embodiment) of the claws 31a, 32a of each magnetic yoke 31, 32 is the same as the number of the N-poles or the S-poles of the multipolar magnet 14. The claws 31a of the magnetic yoke 31 and the claws 32a of the magnetic yoke 32 are alternately arranged one after another while being circumferentially displaced from each other. Thereby, the magnetic yoke 31 is opposed to the magnetic yoke 32 in the axial direction while an air gap is interposed between the magnetic yoke 31 and the magnetic yoke 32 in the axial direction (see FIGS. 3A to 3C). The magnetic yokes 31, 32 form a magnetic circuit in a magnetic field, which is generated by the multipolar magnet 14.

In this instance, the multipolar magnet 14 and the magnetic yokes 31, 32 are arranged such that a circumferential center of each claw 31a, 32a of each magnetic yoke 31, 32 coincides a boundary between a corresponding one of the N-poles and a corresponding one of the S-poles of the multipolar magnet 14 in a state where the torsional displacement is not generated in the torsion bar 13, i.e., where the steering torque is not applied between the input shaft 11 and the output shaft 12.

In the present embodiment, as shown in FIGS. 3A to 3C, the magnetic yokes 31, 32 are integrally resin molded with molding resin 33 to form an integrated yoke unit 30, which serves as an integrated yoke member.

The yoke unit 30 is configured into a bobbin form such that a groove (serving as a space or gap) 34 is formed in an outer peripheral wall of the yoke unit 30, and an axial hole 35 is formed through a center of the yoke unit 30. The groove 34 is axially located in a corresponding position between the ring portion of the magnetic yoke 31 and the ring portion of the magnetic yoke 32, i.e., is formed between the ring portion of the magnetic yoke 31 and the ring portion of the magnetic yoke 32. An outer diameter φDg of a radially inner bottom portion of the groove 34 is smaller than an outer diameter φDo of the yoke unit 30. An inner diameter φDi of the axial hole 35 is slightly larger than an outer diameter of the multipolar magnet 14.

As shown in FIG. 3C, an axial cross section of the magnetic yokes 31, 32 has a form of “L” in a location, at which the claws 31a, 32a are located, and has a form of “−” in a location, at which the claws 31a, 32a are not located. Therefore, the form of “L” and the form of “−” are alternately located in the circumferential direction in the axial cross-section of the magnetic yokes 31, 32.

Similar to the magnetic yokes 31, 32, each of the magnetic flux collecting rings 511, 512 is made of a soft magnetic material and is configured into a semicircular form (semicircular shape), i.e., an arcuate open semi-ring form. The magnetic flux collecting rings 511, 512 are placed in the groove 34 of the yoke unit 30, i.e., are axially placed between the magnetic yoke 31 and the magnetic yoke 32. Therefore, the magnetic flux collecting rings 511, 512 (a majority of the magnetic flux collecting rings 511, 512 except outer peripheral portions of the magnetic flux collecting rings 511, 512 in this embodiment) at least partially overlaps with the magnetic yokes 31, 32 in an axial view (an axial projection) taken in the axial direction. In other words, a radial extent of the magnetic flux collecting rings 511, 512 at last partially overlaps with a radial extent of the magnetic yokes 31, 32, as shown in FIG. 5B. Thereby, the magnetic flux collecting rings 511, 512 are opposed to the ring portions of the magnetic yokes 31, 32 in the axial direction.

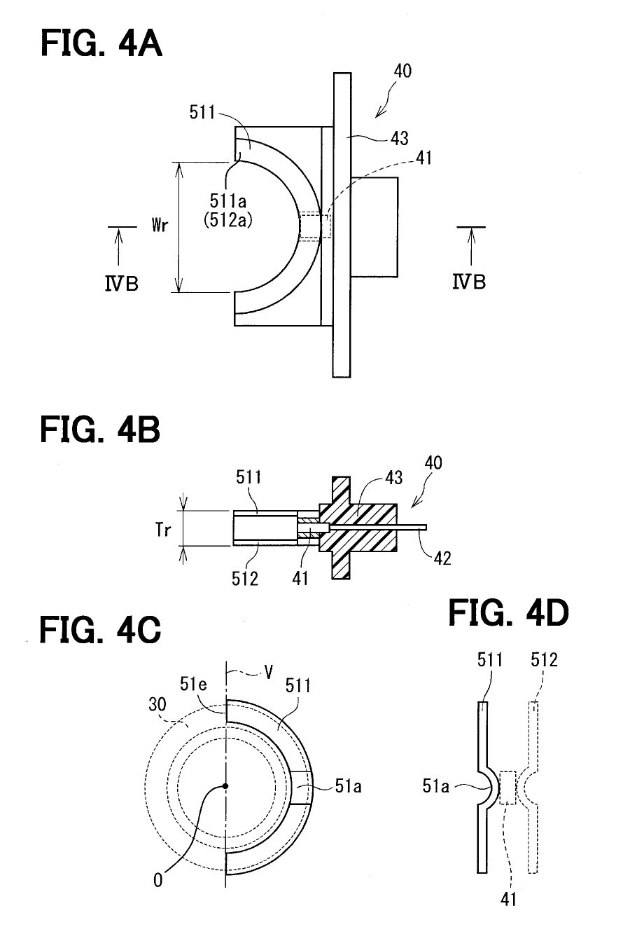

A magnetic flux collecting portion (also referred to as a magnetic flux concentrating portion) 51a, which is configured as a recess, is formed in a circumferential center portion of each of the magnetic flux collecting rings 511, 512, each of which is configured into the semicircular form (see FIGS. 4A to 4C). The magnetic flux collecting portions 51a of the magnetic flux collecting rings 511, 512 are arcuately curved toward the magnetic sensor 41 in the axial direction. Specifically, the magnetic flux collecting portion 51a of the magnetic flux collecting ring 511 and the magnetic flux collecting portion 51a of the magnetic flux collecting ring 512 are closer to each other in the axial direction in comparison to the rest of each of the magnetic flux collecting rings 511, 512. The magnetic flux collecting rings 511, 512 concentrate the magnetic flux, which is supplied from the magnetic yokes 31, 32, into the magnetic flux collecting portions 51a.

The magnetic sensor 41 is placed between the magnetic flux collecting portion 51a of the magnetic flux collecting ring 511 and the magnetic flux collecting portion 51a of the magnetic flux collecting ring 512 to sense a density of the magnetic flux (a strength of a magnetic field) between the magnetic flux collecting portion 51a of the magnetic flux collecting ring 511 and the magnetic flux collecting portion 51a of the magnetic flux collecting ring 512. The magnetic sensor 41 converts the sensed density of the magnetic flux into a corresponding voltage signal and outputs the converted voltage signal to a lead line (electric conductive line) 42. For instance, a Hall element or a magnetoresistive element may be used as the magnetic sensor 41.

In the present embodiment, as shown in FIGS. 4A to 4D, the magnetic flux collecting rings 511, 512 and the magnetic sensor 41 are integrally resin molded with molding resin 43 to form a sensor unit 40. The magnetic sensor 41 is held between the magnetic flux collecting portion 51a of the magnetic flux collecting ring 511 and the magnetic flux collecting portion 51a of the magnetic flux collecting ring 512 such that the magnetic sensor 41 contacts the magnetic flux collecting portions 51a or is placed closest to the magnetic flux collecting portions 51a without contacting the magnetic flux collecting portions 51a in the integrated state of the magnetic sensor 41 in the sensor unit 40.

The sensor unit 40 is configured such that a width Wr of an opening 511a, 512a of each of the magnetic flux collecting rings 511, 512, which opens in a direction perpendicular to the axial direction, is set to be larger than the outer diameter φDg of the radially inner bottom portion of the groove 34. A thickness Tr, which is measured from an upper end surface of the magnetic flux collecting ring 511 to a lower end surface of the magnetic flux collecting ring 512 in the axial direction, is set to be smaller than a height Hg of the groove 34, which is measured in the axial direction. Therefore, the sensor unit 40 can be inserted and installed to the groove 34 from one radial side of the yoke unit 30 such that the openings 511a, 512a of the magnetic flux collecting rings 511, 512 are installed into the groove 34 from the one radial side of the yoke unit 30.

As shown in FIG. 4C, when the sensor unit 40 is installed to the yoke unit 30, the magnetic flux collecting rings 511, 512, which are configured into the semicircular form, circumferentially extend over two or more (at least two) of the magnetic poles of the multipolar magnet 14. Furthermore, end portions (circumferential end portions) 51e of the magnetic flux collecting rings 511, 512 substantially overlap with, i.e., are substantially located in an imaginary plane V, which includes a diameter of the magnetic yokes 31, 32, i.e., which extends through the center of the magnetic yokes 31, 32 in a direction perpendicular to the axial direction (the direction of a central axis O).

Next, an operation of the torque sensor 1 will be described with reference to FIGS. 5A to 6B. FIGS. 5A and 5B show an operational state, in which the claws 32a of the magnetic yoke 32 are radially opposed to the N-poles, respectively, of the multipolar magnet 14. FIGS. 6A and 6B show another operational state, in which the claws 32a of the magnetic yoke 32 are radially opposed to the S-poles, respectively, of the multipolar magnet 14. In FIGS. 5A and 6A, only the claws 32a are indicated by dotted lines, and the claws 31a are not depicted for the sake of simplicity.

In a neutral state, in which the steering torque is not applied between the input shaft 11 and the output shaft 12, and thereby the torsional displacement is not generated in the torsion bar 13, the magnetic yokes 31, 32 are held in an intermediate state, which is circumferentially centered between the state of FIGS. 5A and 5B and the state of FIGS. 6A and 6B. That is, the circumferential center of each of the claws 32a of the magnetic yoke 32 coincides with the boundary between the corresponding N-pole and the corresponding S-pole of the multipolar magnet 14 in the circumferential direction. Furthermore, at this time, the circumferential center of each of the claws 31a of the magnetic yoke 31 coincides with the boundary between the corresponding N-pole and the corresponding S-pole of the multipolar magnet 14 in the circumferential direction.

In this state, the same number of the magnetic lines of force, which flow from each corresponding N-pole to the corresponding S-pole at the multipolar magnet 14, is inputted and outputted at the claws 31a of the magnetic yoke 31 and at the claws 32a of the magnetic yoke 32. Therefore, a closed loop of the magnetic lines of force is generated in the inside of the magnetic yoke 31 and the inside of the magnetic yoke 32. Thereby, the magnetic flux does not leak into the gap between the magnetic yoke 31 and the magnetic yoke 32, so that the density of the magnetic flux, which is sensed with the magnetic sensor 41, becomes zero.

When the steering torque is applied between the input shaft 11 and the output shaft 12 to cause the generation of the torsional displacement in the torsion bar 13, the relative position between the multipolar magnet 14, which is fixed to the input shaft 11, and the magnetic yokes 31, 32, which are fixed to the output shaft 12, changes in the circumferential direction. Thereby, as shown in FIGS. 5A and 5B or FIGS. 6A and 6B, the circumferential center of each of the claws 31a, 32a is displaced from the boundary between the corresponding N-pole and the corresponding S-pole in the circumferential direction. Therefore, the magnetic lines of force of the opposite polarities are increased in the magnetic yoke 31 and the magnetic yoke 32.

In the position shown in FIG. 5A, the magnetic lines of force of the N-polarity are increased in the magnetic yoke 32, and the magnetic lines of force of the S-polarity are increased in the magnetic yoke 31. Therefore, the density Φ1 of the magnetic flux, which passes through the magnetic sensor 41 from the lower side to the upper side in FIG. 5B, is generated.

In the position shown in FIG. 6A, the magnetic lines of force of the S-polarity are increased in the magnetic yoke 32, and the magnetic lines of force of the N-polarity are increased in the magnetic yoke 31. Therefore, the density Φ2 of the magnetic flux, which passes through the magnetic sensor 41 from the upper side to the lower side in FIG. 6B, is generated.

As discussed above, the density of the magnetic flux, which passes through the magnetic sensor 41, is generally proportional to the torsional displacement of the torsion bar 13, and the polarity of the magnetic flux is reversed in response to the direction of the torsion of the torsion bar 13. The magnetic sensor 41 senses the density of this magnetic flux and outputs the sensed density of the magnetic flux as the voltage signal. Thereby, the torque sensor 1 can sense the steering torque between the input shaft 11 and the output shaft 12.

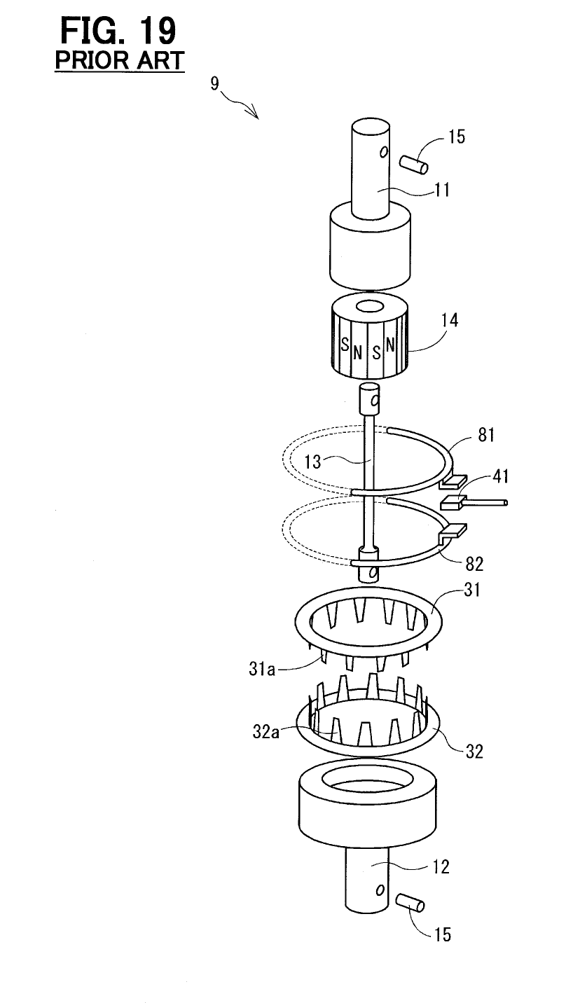

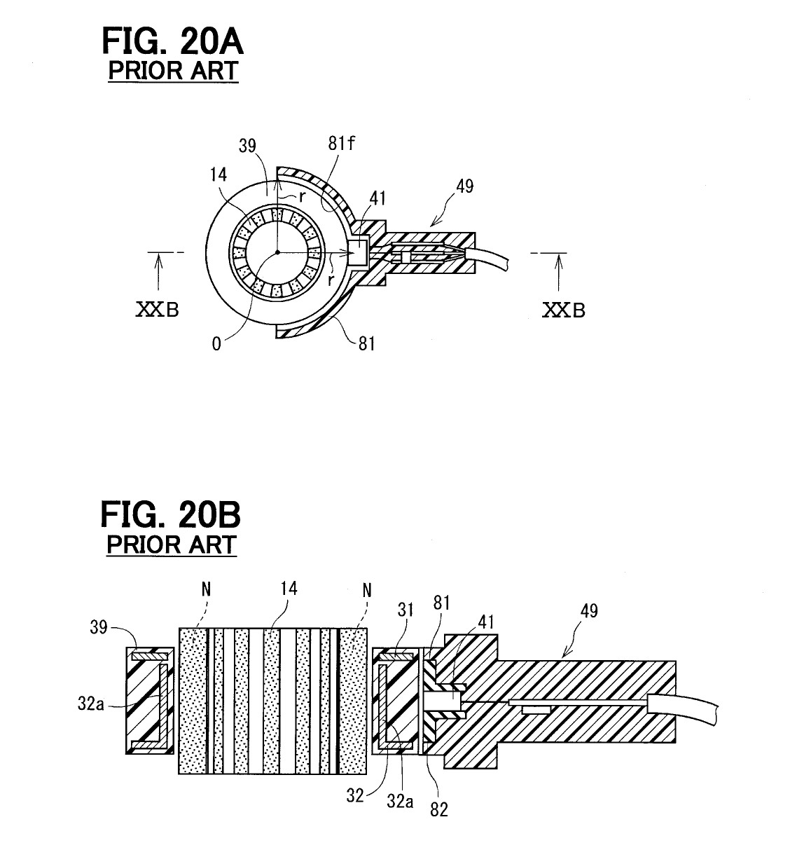

Now, the comparative example, which is based on the technique of JP2003-329523A (corresponding to US2003167857A1), will be described with reference to FIGS. 19 to 20B. The components, which are similar to those of the first embodiment, will be indicated by the same reference numerals and will not be described redundantly.

As shown in FIG. 19, the torque sensor 9 of the comparative example includes two magnetic flux collecting rings 81, 82, each of which is configured into a semicircular form. Furthermore, as shown in FIGS. 20A and 20B, the two magnetic yokes 31, 32 are integrally resin molded to form the yoke unit 39 like in the first embodiment, and the two magnetic flux collecting rings 81, 82 are resin molded together with the magnetic sensor 41 to form the sensor unit 49 like in the first embodiment. However, unlike the first embodiment, the yoke unit 39 of the comparative example does not have the groove in the outer peripheral wall of the yoke unit 39, and the magnetic flux collecting rings 81, 82 are placed radially outward of the magnetic yokes 31, 32.

Next, the advantages of the torque sensor 1 of the present embodiment will be described in comparison to the comparative example.

(1) Similar to the comparative example, the magnetic flux collecting rings 511, 512 are configured into the semicircular form, so that the sensor unit 40 can be installed to the yoke unit 30 in the radial direction in the torque sensor 1 of the present embodiment. Therefore, the assembling efficiency can be improved.

Furthermore, the magnetic flux collecting rings 511, 512 extend over the two or more of the magnetic poles of the multipolar magnet 14 in the circumferential direction.

(2) In the comparative example, the magnetic flux collecting rings 81, 82, each of which is configured into the semicircular form, are placed on the radially outer side of the magnetic yokes 31, 32, i.e., are entirely radially displaced from the magnetic yokes 31, 32 on the radially outer side of the magnetic yokes 31, 32 and are opposed to the magnetic yokes 31, 32 in the radial direction. Therefore, in comparison to the case where each of the magnetic flux collecting rings is configured into the circular form, a total size of the opposed surface areas of the magnetic flux collecting rings 81, 82, which are opposed to the magnetic yokes 31, 32, is reduced to about one half, thereby resulting in a reduction in the amount of the collectable magnetic flux, which can be magnetically collected.

In comparison to this, according to the present embodiment, at least the portion of the magnetic flux collecting rings 511, 512 is overlapped with the magnetic yokes 31, 32 in the axial view, i.e., in the axial projection. Therefore, the magnetic flux collecting rings 511, 512 are opposed to the ring portions of the magnetic yokes 31, 32 in the axial direction, so that the magnetic flux collecting rings 511, 512 can collect the magnetic flux, which is the leaked magnetic flux and is not used in the prior art. As a result, the amount of the collectable magnetic flux is increased.

(3) The magnetic yokes 31, 32 are integrally resin molded to form the yoke unit 30, so that the positional deviation of the magnetic yokes 31, 32 can be limited to stabilize the density of the magnetic flux. Furthermore, the groove 34 is formed in the outer peripheral wall of the yoke unit 30, and the sensor unit 40 can be inserted and installed to the groove 34. Therefore, the assembling efficiency can be improved.

(4) The magnetic flux collecting portions 51a of the magnetic flux collecting rings 511, 512 are closer to each other in the axial direction in comparison to the rest of each of the magnetic flux collecting rings 511, 512. Thus, the magnetic reluctance can be minimized at the location where the magnetic sensor 41 is provided, and thereby the sensitivity of the magnetic sensor 41 can be improved. Furthermore, the magnetic sensor 41 contacts the magnetic flux collecting portions 51a or is placed closest to the magnetic flux collecting portions 51a without contacting the magnetic flux collecting portions 51a. Therefore, the magnetic flux, which is collected at the magnetic flux collecting portions 51a, can be sensed with the magnetic sensor 41 while minimizing the leakage of the collected magnetic flux, which is collected at the magnetic flux collecting portions 51a, and thereby the output of the magnetic sensor 41 is stabilized.

(5) Furthermore, in the present embodiment, the magnetic flux conducting members, which conduct the magnetic flux of the multipolar magnet 14, include the two sets of the magnetic flux conducting members, i.e., the two magnetic yokes 31, 32 and the two magnetic flux collecting rings 511, 512. Therefore, in comparison to the technique of JP2003-329523A (corresponding to US2003167857A1), according to the present embodiment, the number of the components is reduced, and the radial size is reduced. Furthermore, the shapes of the components are simplified in the present embodiment. Therefore, the structure is simplified.

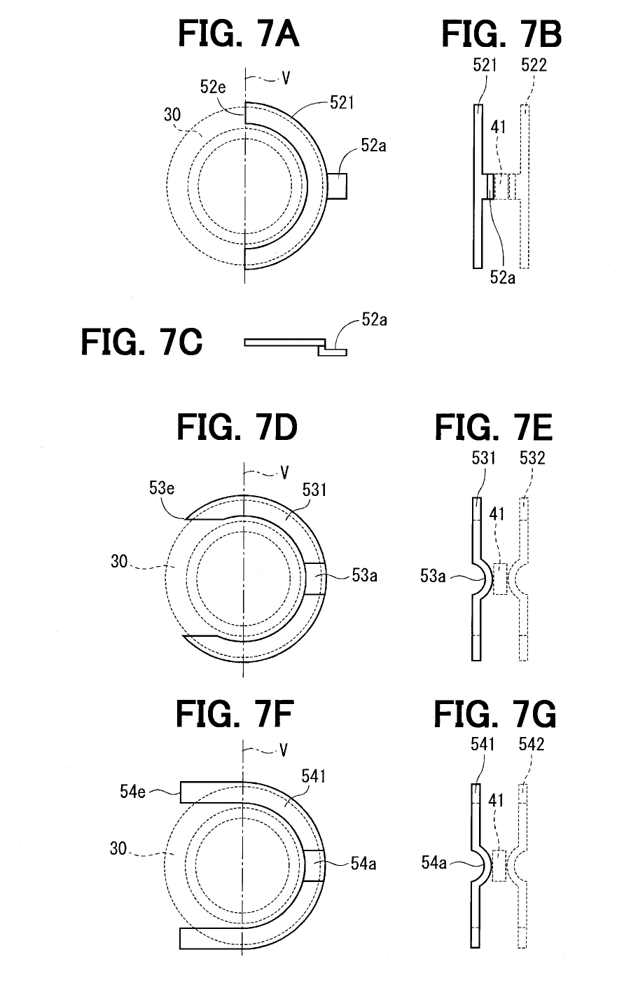

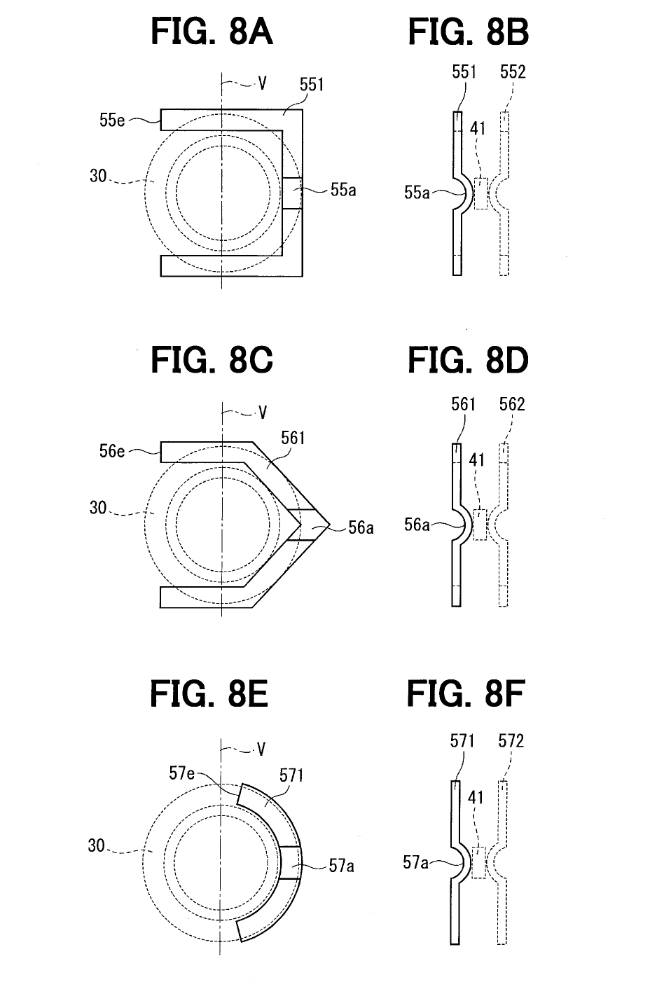

Next, second to sixth embodiments of the present disclosure will be described with reference to FIGS. 7A to 8F. The second to sixth embodiments differ from the first embodiment with respect to the shape of the magnetic flux collecting rings, and the yoke unit 30 and the magnetic sensor 41 are substantially the same as those of the first embodiment.

### Second Embodiment

As shown in FIGS. 7A, 7B and 7C, each of the magnetic flux collecting rings 521, 522 of the second embodiment has a magnetic flux collecting portion 52a, which is formed as a projection that radially outwardly projects from a ring main body of the magnetic flux collecting ring 521, 522 that is configured into a semicircular form (semicircular shape). Furthermore, the magnetic flux collecting portion 52a of each of the magnetic flux collecting rings 521, 522 is bent such that the magnetic sensor 41 contacts the magnetic flux collecting portions 52a or is placed closest to the magnetic flux collecting portions 52a without contacting the magnetic flux collecting portions 52a. The end portions 52e of the magnetic flux collecting rings 521, 522 substantially overlap with, i.e., are substantially located in the imaginary plane V.

### Third Embodiment

As shown in FIGS. 7D and 7E, the magnetic flux collecting rings 531, 532 of the third embodiment are configured into a form of “C” such that end portions 53e extend beyond the imaginary plane V, and an outer peripheral edge of an exceeding part of the end portion 53e, which extends beyond the imaginary plane V, is arcuate. A magnetic flux collecting portion 53a of each of the magnetic flux collecting rings 531, 532 is configured into a shape, which is similar to that of the magnetic flux collecting portion 51a of the first embodiment.

In comparison to the first embodiment, the total size of the opposed surface areas of the magnetic flux collecting rings 531, 532, which are opposed to the magnetic yokes 31, 32 of the yoke unit 30, is increased in the third embodiment, thereby resulting in an increase in the amount of the collectable magnetic flux, which can be magnetically collected.

### Fourth Embodiment

As shown in FIGS. 7F and 7G, the magnetic flux collecting rings 541, 542 of the fourth embodiment are configured into a shape of “U” such that end portions 54e extend beyond the imaginary plane V, and an outer edge of an extended part of the end portion 54e, which extends beyond the imaginary plane V, is linear. A magnetic flux collecting portion 54a of each of the magnetic flux collecting rings 541, 542 is configured into a shape, which is similar to that of the magnetic flux collecting portion 51a of the first embodiment.

In comparison to the first embodiment, the opposed surface area of the magnetic flux collecting rings 541, 542, which are opposed to the magnetic yokes 31, 32 of the yoke unit 30, is increased in the fourth embodiment, thereby resulting in an increase in the amount of the collectable magnetic flux, which can be magnetically collected. Furthermore, in comparison to the third embodiment, the acute edge of the end portion 54e is eliminated in the fourth embodiment, so that chipping of the end portion 54e can be limited.

### Fifth and Sixth Embodiments

The shape of the magnetic flux collecting rings is not limited to the shapes, each of which basically has the semicircular form like in the above embodiments. For instance, as shown in FIGS. 8A and 8B, it is possible to have the magnetic flux collecting rings 551, 552 of the fifth embodiment, which are configured into a quadrate based shape, more specifically a shape of “η”(Greek capital Pi) that is formed by three right angled lines. Furthermore, as shown in FIGS. 8C and 8D, it is possible to have the magnetic flux collecting rings 561, 562 of the sixth embodiment, which are configured into a polygon based shape, more specifically, a shape of “V” with two parallel ends.

Each of magnetic flux collecting portions 55a, 56a of the fifth and sixth embodiments is configured into a shape similar to the shape of the magnetic flux collecting portion 51a of the first embodiment, and two end portions 55e, 56e extend beyond the imaginary plane V.

### Seventh Embodiment

Each of two magnetic flux collecting rings 571, 572 of the seventh embodiment shown in FIGS. 8E and 8F is configured into a partially arcuate form (partially arcuate shape), which is smaller than the semicircular form of the magnetic flux collecting ring 511, 512 of the first embodiment in the circumferential direction. Two end portions 57e of each magnetic flux collecting ring 571, 572 are placed on a magnetic flux collecting portion 57a side of the imaginary plane V. Even in this case, the magnetic flux collecting rings 571, 572 extend over two or more of the magnetic poles of the multipolar magnet 14 in the circumferential direction. As discussed above, the shape of the magnetic flux collecting ring, which basically has the semicircular form, can be any of the semicircular form, the arcuate form having the size smaller than that of the semicircular form or the arcuate form having the size larger than that of the semicircular form.

Now, modifications of the first to seventh embodiments will be described.

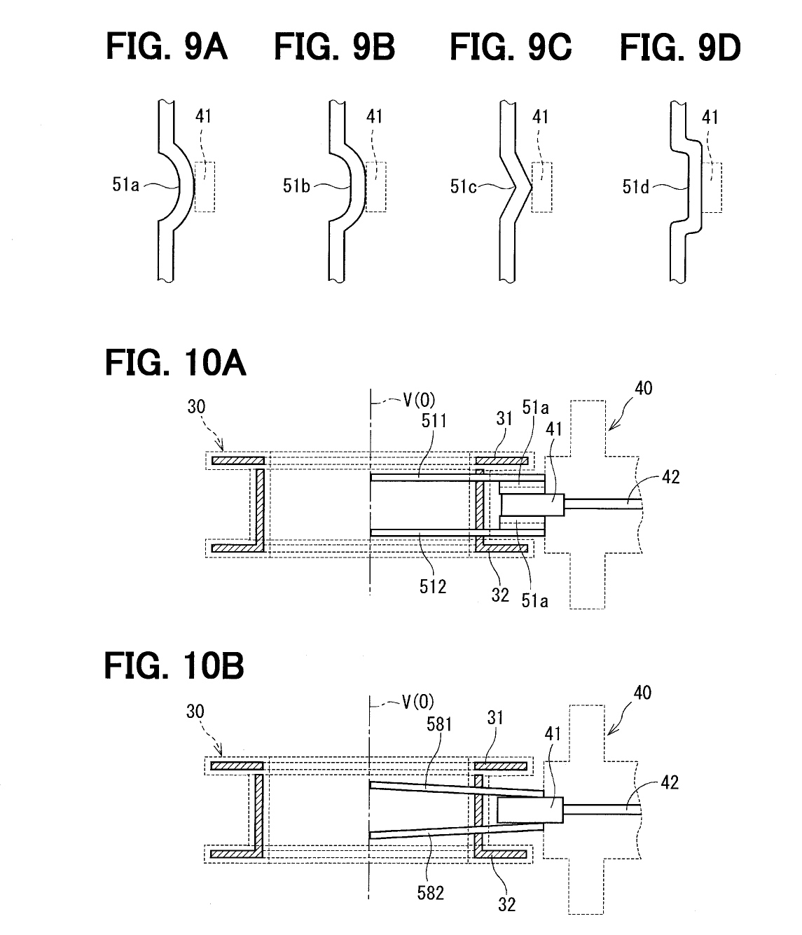

(A) FIGS. 9A to 9D show various exemplary shapes of the magnetic flux collecting portion. Besides the magnetic flux collecting portion 51a of the first embodiment, which has the arcuate shape shown in FIG. 9A, it is possible to configure the magnetic flux collecting portion into, for example, a magnetic flux collecting portion 51b having a saucer shape shown in FIG. 9B, a magnetic flux collecting portion 51c having a V-shape shown in FIG. 9C, or a magnetic flux collecting portion 51d having a rectangular trench shape shown in FIG. 9D.

The magnetic flux collecting portion 51c of FIG. 9C can concentrate the magnetic flux into a single point, so that the magnetic sensor 41 shows the best sensitivity.

The magnetic flux collecting portion 51d of FIG. 9D make a planar surface to planar surface contact relative to the magnetic sensor 41, so that the robustness (tolerance) against the positional deviation of the magnetic sensor 41 in the direction perpendicular to the axial direction can be improved.

(B) FIGS. 10A and 10B shown positioning examples of the magnetic flux collecting rings. In the first embodiment, the magnetic flux collecting rings 511, 512 are placed generally parallel to the magnetic yokes 31, 32 of the yoke unit 30, as shown in FIG. 10A. Alternatively, as shown in FIG. 10B, the magnetic flux collecting rings 511, 512 may be tilted relative to the magnetic yokes 31, 32 such that the a distance between the magnetic flux collecting rings 581, 582 is increased on the imaginary plane V side and is decreased on the magnetic sensor 41 side. In this way, the magnetic flux collecting portion and the magnetic sensor 41 can contact with each other or can be placed closed to each other as much as possible by simply forming a small recess as the magnetic flux collecting portion. Alternatively, the magnetic flux collecting portion may be eliminated.

(C) In the above embodiments, the multipolar magnet 14 is fixed to the input shaft 11, and the two magnetic yokes 31, 32 are fixed to the output shaft 12. Alternatively, the multipolar magnet 14 may be fixed to the output shaft 12, and the two magnetic yokes 31, 32 may be fixed to the input shaft 11. Furthermore, the multipolar magnet 14 may be fixed to the one end portion of the torsion bar 13, and the two magnetic yokes 31, 32 may be fixed to the other end portion of the torsion bar 13. This is also applicable to the following embodiments and modifications thereof.

(D) The two magnetic yokes 31, 32 may not need to be resin molded and may not need to form the yoke unit 30. Furthermore, the two magnetic flux collecting rings 511, 512 and the magnetic sensor 41 may not need to be integrally resin molded and may not need to form the sensor unit 40. This is also applicable to the following embodiments and modifications thereof.

(E) The application of the torque sensor of the present disclosure is not limited to the electric power steering apparatus and may be applied to various other apparatuses, which sense the shaft torque. This is also applicable to the following embodiments and modifications thereof.

### Eighth Embodiment

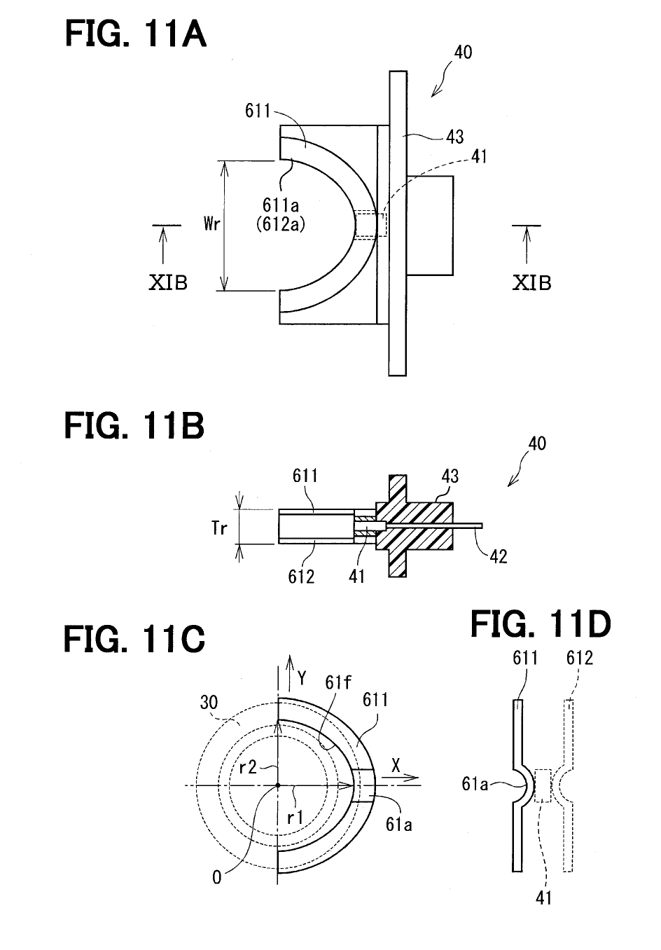

Now, an eighth embodiment of the present disclosure will be described with reference to FIGS. 11A to 13B as well as FIGS. 1 to 3C of the first embodiment. The eighth embodiment is a modification of the first embodiment. More specifically, the eighth embodiment differs from the first embodiment with respect to the configuration and arrangement of two magnetic flux collecting rings 611, 612, which are provided in place of the two magnetic flux collecting rings 511, 512 of the first embodiment, and the rest of the structure is substantially the same as that of first embodiment. Therefore, similar components, which are similar to those discussed in the first embodiment will be indicated by the same reference numerals and will not be redundantly discussed in detail for the sake of simplicity.

In the eighth embodiment, similar to the magnetic yokes 31, 32, each of the magnetic flux collecting rings 611, 612 is made of a soft magnetic material and is configured into a semielliptical form. The magnetic flux collecting rings 611, 612 are placed in the groove 34 of the yoke unit 30, i.e., are axially placed between the magnetic yoke 31 and the magnetic yoke 32. Therefore, the magnetic flux collecting rings 611, 612 at least partially overlaps with the magnetic yokes 31, 32 in the axial view (in the axial projection). In other words, a radial extent of the magnetic flux collecting rings 611, 612 at last partially overlaps with a radial extent of the magnetic yokes 31, 32. Thereby, the magnetic flux collecting rings 611, 612 are opposed to the ring portions of the magnetic yokes 31, 32 in the axial direction.

The magnetic flux collecting portion (also referred to as the magnetic flux concentrating portion) 61a, which is configured as a recess, is formed in a circumferential center portion of each of the magnetic flux collecting rings 611, 612, each of which is configured into the semielliptical form (see FIGS. 11A to 11C). The magnetic flux collecting portions 61a of the magnetic flux collecting rings 611, 612 are arcuately curved toward the magnetic sensor 41 in the axial direction. Specifically, the magnetic flux collecting portion 61a of the magnetic flux collecting ring 611 and the magnetic flux collecting portion 61a of the magnetic flux collecting ring 612 are closer to each other in the axial direction in comparison to the rest of each of the magnetic flux collecting rings 611, 612. The magnetic flux collecting rings 611, 612 concentrate the magnetic flux, which is supplied form the magnetic yokes 31, 32, into the magnetic flux collecting portions 61a.

The magnetic sensor 41 is placed between the magnetic flux collecting portion 61a of the magnetic flux collecting ring 611 and the magnetic flux collecting portion 61a of the magnetic flux collecting ring 612 to sense a density of the magnetic flux (a strength of a magnetic field) between the magnetic flux collecting portion 61a of the magnetic flux collecting ring 611 and the magnetic flux collecting portion 61a of the magnetic flux collecting ring 612. The magnetic sensor 41 converts the sensed density of the magnetic flux into the corresponding voltage signal and outputs the converted voltage signal to the lead line (electric conductive line) 42. For instance, a Hall element or a magnetoresistive element may be used as the magnetic sensor 41.

In the present embodiment, as shown in FIGS. 11A to 11D, the magnetic flux collecting rings 611, 612 and the magnetic sensor 41 are integrally resin molded with molding resin 43 to form the sensor unit 40. The magnetic sensor 41 is held between the magnetic flux collecting portion 61a of the magnetic flux collecting ring 611 and the magnetic flux collecting portion 61a of the magnetic flux collecting ring 612 such that the magnetic sensor 41 contacts the magnetic flux collecting portions 61a or is placed closest to the magnetic flux collecting portions 61a without contacting the magnetic flux collecting portions 61a in the integrated state of the magnetic sensor 41 in the sensor unit 40.

The sensor unit 40 is configured such that the width Wr of the opening 611a, 612a of each of the magnetic flux collecting rings 611, 612, which opens in the direction perpendicular to the axial direction, is set to be larger than the outer diameter φDg of the radially inner bottom portion of the groove 34 (see FIG. 3B). A thickness Tr, which is measured from an upper end surface of the magnetic flux collecting ring 611 to a lower end surface of the magnetic flux collecting ring 612 in the axial direction, is set to be smaller than the height Hg of the groove 34 (see FIG. 3B), which is measured in the axial direction. Therefore, the sensor unit 40 can be inserted and installed to the groove 34 from one radial side of the yoke unit 30 such that the openings 611a, 612a of the magnetic flux collecting rings 611, 612 are installed into the groove 34 from the one radial side of the yoke unit 30.

With reference to FIGS. 11C and 11D, each of the magnetic flux collecting rings 611, 612 is configured as follows. That is, a distance from a central axis O of the yoke unit 30 to an inner peripheral edge 61f of the magnetic flux collecting ring 611, 612 measured in a radial direction X (a direction of a major axis of an imaginary ellipse, along which magnetic flux collecting ring 611, 612 configured into the semielliptical form extends) corresponds to a major radius r1 of the ellipse, and a distance from the central axis O of the yoke unit 30 to the inner peripheral edge 61f of the magnetic flux collecting ring 611, 612 measured in a radial direction Y, which is perpendicular to the direction X, corresponds to a minor radius r2 of the ellipse. Specifically, the distance from the central axis O of the yoke unit 30 to the inner peripheral edge 61f of the magnetic flux collecting ring 611, 612 is set to be maximum in the direction X along an imaginary line, which radially connects between the central axis O and the magnetic sensor 41, and the distance from the central axis O of the yoke unit 30 to the inner peripheral edge 61f of the magnetic flux collecting ring 611, 612 is set to be minimum in the direction Y. The distance from the central axis O of the yoke unit 30 to the inner peripheral edge 61f of the magnetic flux collecting ring 611, 612 continuously increases from the direction Y side to the direction X side.

Here, the central axis O of the yoke unit 30 coincides with the central axis O f the multipolar magnet 14 in the installed state of the torque sensor 1 (see FIGS. 1 and 12A-13B). Therefore, in other words, the distance from the central axis O of the multipolar magnet 14 to the inner peripheral edge 61f of the magnetic flux collecting ring 611, 612 is set to be maximum in the direction X and is set to be minimum in the direction Y.

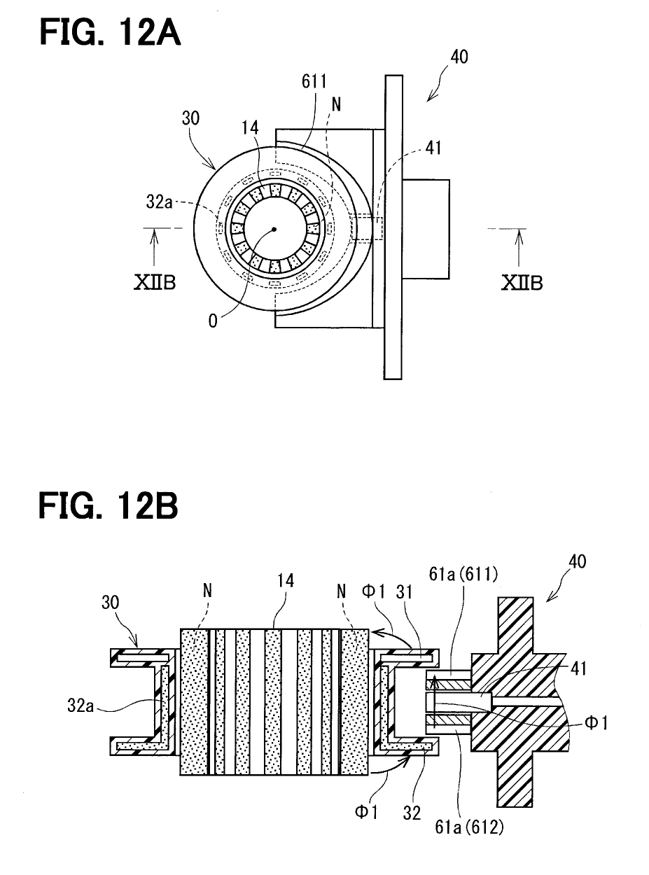

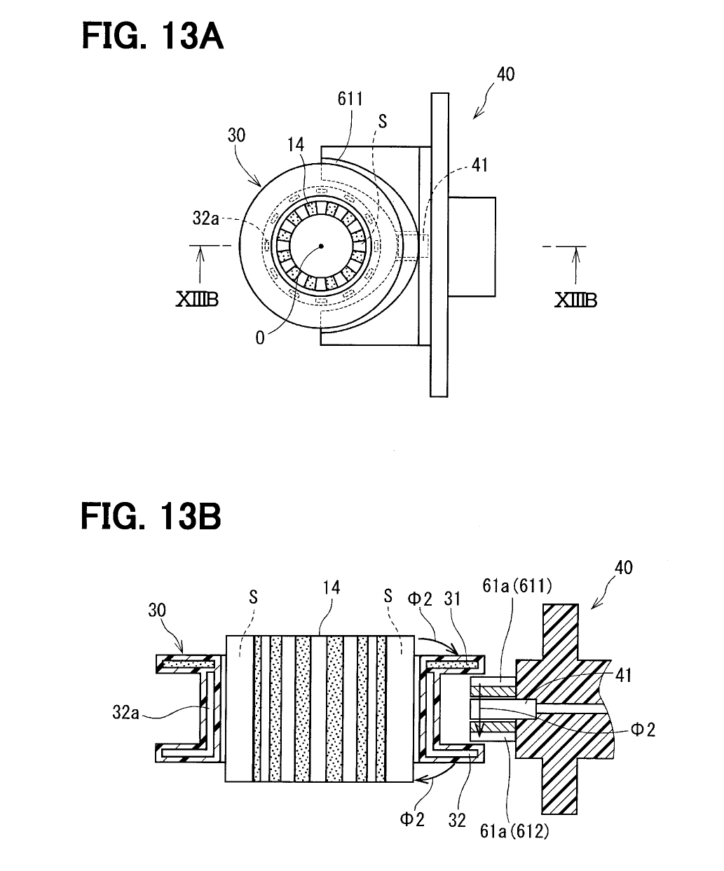

Next, an operation of the torque sensor 1 will be described with reference to FIGS. 12A to 13B. FIGS. 12A and 12B show a state, in which the claws 32a of the magnetic yoke 32 are radially opposed to the N-poles, respectively, of the multipolar magnet 14. FIGS. 13A and 13B show another state, in which the claws 32a of the magnetic yoke 32 are radially opposed to the S-poles, respectively, of the multipolar magnet 14. In FIGS. 12A and 13A, only the claws 32a are indicated by dotted lines, and the claws 31a are not depicted for the sake of simplicity.

In the neutral state, in which the steering torque is not applied between the input shaft 11 and the output shaft 12, and thereby the torsional displacement is not generated in the torsion bar 13, the magnetic yokes 31, 32 are held in the intermediate state, which is circumferentially centered between the state of FIGS. 12A and 12B and the state of FIGS. 13A and 13B. That is, the circumferential center of each of the claws 32a of the magnetic yoke 32 coincides with the boundary between the corresponding N-pole and the corresponding S-pole of the multipolar magnet 14 in the circumferential direction. Furthermore, at this time, the circumferential center of each of the claws 31a of the magnetic yoke 31 coincides with the boundary between the corresponding N-pole and the corresponding S-pole of the multipolar magnet 14 in the circumferential direction.

In this state, the same number of the magnetic lines of force, which flow from each corresponding N-pole to the corresponding S-pole at the multipolar magnet 14, is inputted and outputted at the claws 31a of the magnetic yoke 31 and at the claws 32a of the magnetic yoke 32. Therefore, a closed loop of the magnetic lines of force is generated in the inside of the magnetic yoke 31 and the inside of the magnetic yoke 32. Thereby, the magnetic flux does not leak into the gap between the magnetic yoke 31 and the magnetic yoke 32, so that the density of the magnetic flux, which is sensed with the magnetic sensor 41, becomes zero.

When the steering torque is applied between the input shaft 11 and the output shaft 12 to cause the generation of the torsional displacement in the torsion bar 13, the relative position between the multipolar magnet 14, which is fixed to the input shaft 11, and the magnetic yokes 31, 32, which are fixed to the output shaft 12, changes in the circumferential direction. Thereby, as shown in FIGS. 12A and 12B or FIGS. 13A and 13B, the circumferential center of each of the claws 31a, 32a is displaced from the boundary between the corresponding N-pole and the corresponding S-pole in the circumferential direction. Therefore, the magnetic lines of force of the opposite polarities are increased in the magnetic yoke 31 and the magnetic yoke 32.

In the position shown in FIG. 12A, the magnetic lines of force of the N-polarity are increased in the magnetic yoke 32, and the magnetic lines of force of the S-polarity are increased in the magnetic yoke 31. Therefore, the density Φ1 of the magnetic flux, which passes through the magnetic sensor 41 from the lower side to the upper side in FIG. 12B, is generated.

In the position shown in FIG. 13A, the magnetic lines of force of the S-polarity are increased in the magnetic yoke 32, and the magnetic lines of force of the N-polarity are increased in the magnetic yoke 31. Therefore, the density Φ2 of the magnetic flux, which passes through the magnetic sensor 41 from the upper side to the lower side in FIG. 13B, is generated.

As discussed above, the density of the magnetic flux, which passes through the magnetic sensor 41, is generally proportional to the torsional displacement of the torsion bar 13, and the polarity of the magnetic flux is reversed in response to the direction of the torsion of the torsion bar 13. The magnetic sensor 41 senses the density of this magnetic flux and outputs the sensed density of the magnetic flux as the voltage signal. Thereby, the torque sensor 1 can sense the steering torque between the input shaft 11 and the output shaft 12.

Now, the comparative example, which is based on the technique of JP2003-329523A (corresponding to US2003167857A1), will be described with reference to FIGS. 19 to 20B.

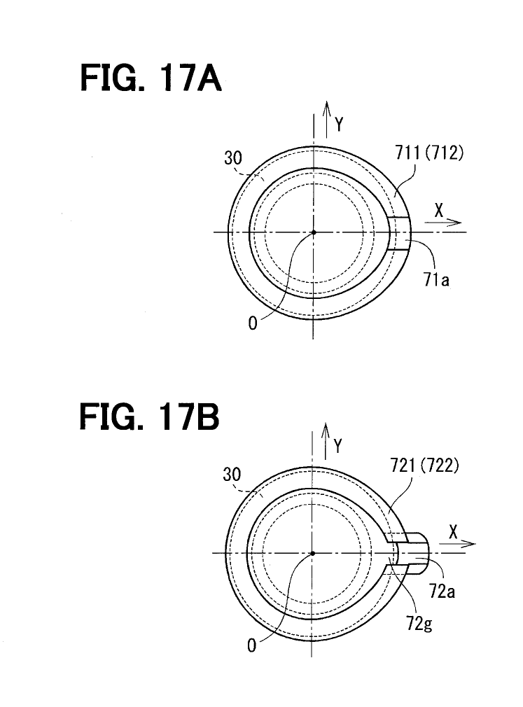

As shown in FIG. 19, the torque sensor 9 of the comparative example includes two magnetic flux collecting rings 81, 82, each of which is configured into an open semi-ring form, more specifically a semicircular form. Furthermore, as shown in FIGS. 17A and 17B, the two magnetic yokes 31, 32 are integrally resin molded to form the yoke unit 39 like in the eighth embodiment, and the two magnetic flux collecting rings 81, 82 are resin molded together with the magnetic sensor 41 to form the sensor unit 49 like in the eighth embodiment.

However, each of the two magnetic flux collecting rings 81, 82 of the comparative example is the semicircular form, so that a distance from the central axis O to an inner peripheral edge 91f measured in the direction X is the same as a distance from the central axis O to the inner peripheral edge 91f measured in the direction Y unlike the eighth embodiment.

Next, the advantages of the torque sensor 1 of the present embodiment will be described in comparison to the comparative example.

(1) The magnetic flux collecting rings 611, 612 are configured into the open semi-ring form, so that the sensor unit 40 can be installed to the yoke unit 30 in the radial direction in the torque sensor 1 of the present embodiment like in the comparative example. Therefore, the assembling efficiency can be improved.

(2) In the comparative example, the magnetic flux collecting rings 81, 82, each of which is configured into the semicircular form, are placed on the radially outer side of the magnetic yokes 31, 32, i.e., are entirely radially displaced from the magnetic yokes 31, 32 on the radially outer side of the magnetic yokes 31, 32 and are opposed to the magnetic yokes 31, 32 in the radial direction. Therefore, in comparison to the case where each of the magnetic flux collecting rings is configured into the circular form, a total size of the opposed surface areas of the magnetic flux collecting rings 81, 82, which are opposed to the magnetic yokes 31, 32, is reduced to about one half, thereby resulting in a reduction in the amount of the collectable magnetic flux, which can be magnetically collected.

In order to increase the amount of the magnetic flux, which can be magnetically collected, for instance, the two magnetic flux collecting rings may be axially placed between the two magnetic yokes 31, 32 such that the tow magnetic flux collecting rings are axially opposed to the two magnetic yokes 31, 32. In such a case, when the magnetic sensor 41 is placed excessively close to the multipolar magnet 14, which is located on the radially inner side of the magnetic sensor 41, the magnetic sensor 41 may be influenced by a periodic change of the magnetic flux caused by the torsional displacement of the torsion bar 13. Therefore, at the time of rotating the torsion bar 13 in the state where the constant torque is applied to the torsion bar 13, the output voltage of the magnetic sensor 41 may be periodically changed.

Particularly, in the case where each of the two magnetic flux collecting rings is configured into the open semi-ring form, an extent of each of the two magnetic flux collecting rings is reduced in comparison to the case where each of the two magnetic flux collecting rings is configured into the closed annular ring form. Thereby, the smoothening effect for smoothening the magnetic flux is reduced, and the influence of the change of the magnetic flux becomes large.

In contrast, according to the present embodiment, the two magnetic flux collecting rings 611, 612 are configured such that the distance from the central axis O of the multipolar magnet 14 to the inner peripheral edge 61f of the magnetic flux collecting ring 611, 612 is set to be maximum in the direction X. That is, the magnetic sensor 41 is placed at the location, which is spaced from the multipolar magnet 14 as much as possible. Thereby, the influence of the periodic change of the magnetic flux on the magnetic sensor 41 is limited. As a result, the output voltage of the magnetic sensor 41 can be stabilized.

In the present embodiment, the two magnetic flux collecting rings 611, 612 are configured such that the distance from the central axis O of the multipolar magnet 14 to the inner peripheral edge 61f of the magnetic flux collecting ring 611, 612 is set to be minimum in the direction Y, and the distance from the central axis O of the multipolar magnet 14 to the inner peripheral edge 61f of the magnetic flux collecting ring 611, 612 continuously increases from the direction Y side to the direction X side.

As the multipolar magnet 14 is spaced further from the magnetic flux collecting portions 61a of the two magnetic flux collecting rings 611, 612, i.e., is spaced further from the magnetic sensor 41, the influence of the change of the magnetic flux on the magnetic sensor 41 is reduced even in the case where the distance between the two magnetic flux collecting rings 611, 612 and the multipolar magnet 14 is small. Therefore, the configuration of each of the two magnetic flux collecting rings 611, 612 can be set such that the distance between the multipolar magnet 14 and the magnetic flux collecting ring 611, 612 is set to be minimum in the direction Y, which is rotated by ±90 degrees from the magnetic flux collecting portion 61a.

(3) In the present embodiment, the two magnetic flux collecting rings 611, 612 at least partially overlap with the two magnetic yokes 31, 32 in the axial view (in the axial projection). Therefore, the magnetic flux collecting rings 611, 612 are opposed to the ring portions of the magnetic yokes 31, 32 in the axial direction, so that the magnetic flux collecting rings 611, 612 can collect the magnetic flux, which is the leaked magnetic flux and is not used in the prior art. As a result, the amount of the collectable magnetic flux is increased.

(4) The magnetic flux collecting portions 61a of the magnetic flux collecting rings 611, 612 are closer to each other in the axial direction in comparison to the rest of each of the magnetic flux collecting rings 611, 612. Thus, the magnetic reluctance can be minimized at the location where the magnetic sensor 41 is provided, and thereby the sensitivity of the magnetic sensor 41 can be improved. Furthermore, the magnetic sensor 41 contacts the magnetic flux collecting portions 61a or is placed closest to the magnetic flux collecting portions 61a without contacting the magnetic flux collecting portions 61a. Therefore, the magnetic flux, which is collected at the magnetic flux collecting portions 61a, can be sensed with the magnetic sensor 41 while minimizing the leakage of the collected magnetic flux, which is collected at the magnetic flux collecting portions 61a, and thereby the output of the magnetic sensor 41 is stabilized.

(5) The magnetic yokes 31, 32 are integrally resin molded to form the yoke unit 30, so that the positional deviation of the magnetic yokes 31, 32 can be limited to stabilize the density of the magnetic flux. Furthermore, the groove 34 is formed in the outer peripheral wall of the yoke unit 30, and the sensor unit 40 can be inserted and installed to the groove 34. Therefore, the assembling efficiency can be improved.

(6) Furthermore, in the present embodiment, the magnetic flux conducting members, which conduct the magnetic flux of the multipolar magnet 14, include the two sets of the magnetic flux conducting members, i.e., the two magnetic yokes 31, 32 and the two magnetic flux collecting rings 611, 612. Therefore, in comparison to the technique of JP2003-329523A (corresponding to US2003167857A1), according to the present embodiment, the number of the components is reduced, and the radial size is reduced. Furthermore, the shapes of the components are simplified in the present embodiment. Therefore, the structure is simplified.

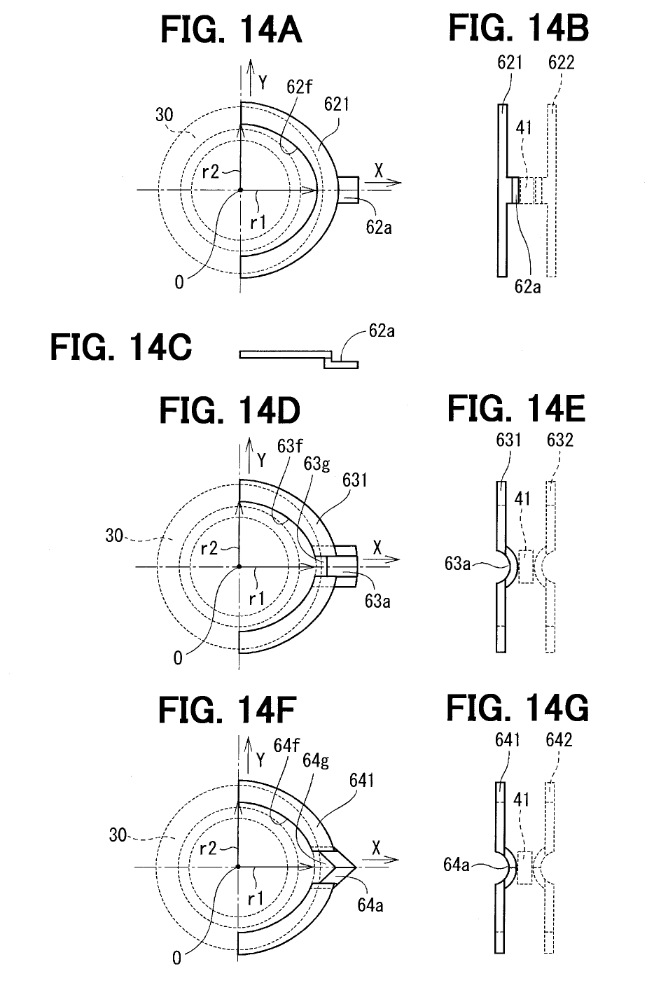

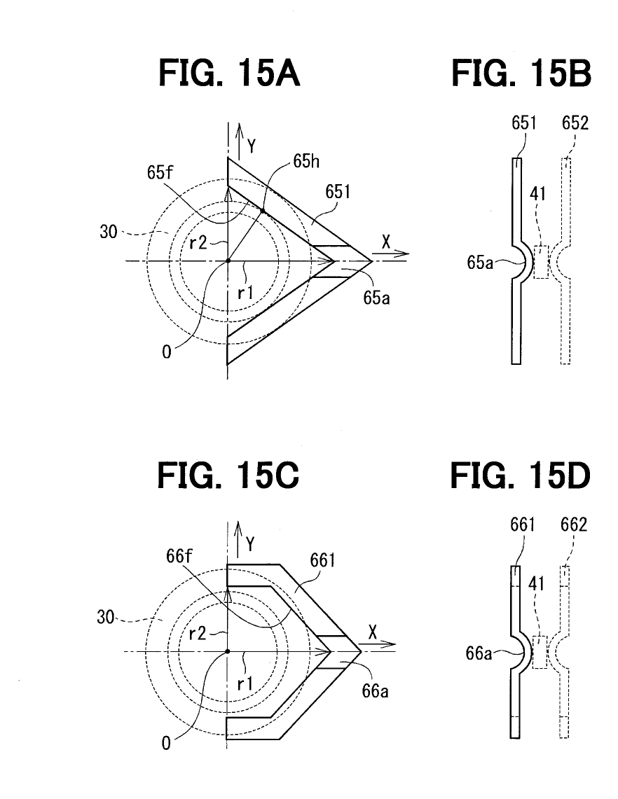

Next, ninth to thirteenth embodiments of the present disclosure will be described with reference to FIGS. 14A to 15D. The ninth to thirteenth embodiments differ from the eighth embodiment with respect to the shape of the magnetic flux collecting rings, and the yoke unit 30 and the magnetic sensor 41 are substantially the same as those of the eighth embodiment.

Furthermore, similar to the eighth embodiment, a basic configuration of each of the two magnetic flux collecting rings is the semielliptical form in the ninth to eleventh embodiments. Specifically, the distance from the central axis O of the multipolar magnet 14 to the inner peripheral edge 61f of the magnetic flux collecting ring 611, 612 is set to be maximum in the direction X, along with the central axis O and the magnetic sensor 41 are located, and is set to be minimum in the direction Y. The distance from the central axis O of the multipolar magnet 14 to the inner peripheral edge 61f of the magnetic flux collecting ring 611, 612 continuously increases from the direction Y side to the direction X side.

### Ninth Embodiment

As shown in FIGS. 14A to 14C, each of the magnetic flux collecting rings 621, 622 of the ninth embodiment has a magnetic flux collecting portion 62a, which is formed as a projection that radially outwardly projects from a ring main body of the magnetic flux collecting ring 621, 622 that is configured into a semielliptical form. Furthermore, the magnetic flux collecting portion 62a of each of the magnetic flux collecting rings 621, 622 is bent such that the magnetic sensor 41 contacts the magnetic flux collecting portions 62a or is placed closest to the magnetic flux collecting portions 62a without contacting the magnetic flux collecting portions 62a.

Furthermore, the distance from the central axis O of the multipolar magnet 14 to the inner peripheral edge 62f of the magnetic flux collecting ring 621, 622 is set to be maximum in the direction X and is set to be minimum in the direction Y. Furthermore, the distance from the central axis O of the multipolar magnet 14 to the inner peripheral edge 62f of the magnetic flux collecting ring 621, 622 continuously increases from the direction Y side to the direction X side.

### Tenth Embodiment

As shown in FIGS. 14D and 14E, each of the magnetic flux collecting rings 631, 632 of the tenth embodiment has a radial recess 63g, which is arcuate (or rectangular) in the radial direction and radially outwardly recessed in the inner peripheral edge 63f of the magnetic flux collecting ring 631, 632 along the direction X such that the distance from the central axis O of the multipolar magnet 14 to the inner peripheral edge 63f of the magnetic flux collecting ring 631, 632 discontinuously increases from a circumferentially adjacent part of the inner peripheral edge 63f, which is circumferentially adjacent to the radial recess 63g, to the radial recess 63g from the direction Y side to the direction X side. Therefore, the distance from the central axis O of the multipolar magnet 14 to the inner peripheral edge 63f of the magnetic flux collecting ring 631, 632 is further increased at the radial recess 63g. As a result, the influence of the change of the magnetic field is further reduced at the magnetic flux collecting portion 63a.

### Eleventh Embodiment

As shown in FIGS. 14F and 14G, each of the magnetic flux collecting rings 641, 642 of the eleventh embodiment has a V-shaped recess 64g, which is radially outwardly recessed in the inner peripheral edge 64f of the magnetic flux collecting ring 641, 642 along the direction X such that the distance from the central axis O of the multipolar magnet 14 to the inner peripheral edge 64f of the magnetic flux collecting ring 641, 642 discontinuously increases from a circumferentially adjacent part of the inner peripheral edge 64f, which is circumferentially adjacent to the V-shaped recess 64g, to the V-shaped recess 64g from the direction Y side to the direction X side. Therefore, the distance from the central axis O of the multipolar magnet 14 to the inner peripheral edge 64f of the magnetic flux collecting ring 641, 642 is further increased at the V-shaped recess 64g. As a result, the influence of the change of the magnetic field is further reduced at the magnetic flux collecting portion 64a.

### Twelfth and Thirteenth Embodiments

The shape of the magnetic flux collecting rings may be a triangular shape as in a case of the magnetic flux collecting rings 651, 652 of the twelfth embodiment shown in FIGS. 15A and 15B. In such a case, the distance from the central axis O of the multipolar magnet 14 to the inner peripheral edge 65f of each of the magnetic flux collecting ring 651, 652 is set to be maximum in the direction X and is set to be minimum at a point 65h, which is located along the inner peripheral edge 65f and is displaced from the direction Y on the side where the magnetic sensor 41 is located. Furthermore, the shape of the magnetic flux collecting rings may be a polygonal shape as in a case of the magnetic flux collecting rings 661, 662 of the thirteenth embodiment shown in FIGS. 15C and 15D. In such a case, the distance from the central axis O of the multipolar magnet 14 to the inner peripheral edge 66f of each of the magnetic flux collecting ring 661, 662 is set to be maximum in the direction X and is set to be minimum in the direction Y.

Furthermore, in the twelfth and thirteenth embodiments, the magnetic sensor 41 is radially outwardly displaced from the magnetic yokes 31, 32 in the axial view (in the axial projection). Similar to the magnetic flux collecting portion 61a of each magnetic flux collecting ring 611, 612 of the eighth embodiment, the magnetic flux collecting portion 65a, 66a of each magnetic flux collecting ring 651, 652, 661, 662 of the twelfth and thirteenth embodiments has the arcuate shape, which is arcuately curved in the axial direction.

Now, modifications o the eighth to thirteenth embodiments will be described.

(A) The magnetic flux collecting portion 61a of the eighth embodiment has the arcuate shape, which is similar to the arcuate shape of the magnetic flux collecting portion 51a of the first embodiment shown in FIG. 9A. As discussed with reference to FIGS. 9B to 9D, the magnetic flux collecting portions of the eighth to thirteenth embodiments may be modified to the have the shape similar to any one of the magnetic flux collecting portions 51b-51d of FIGS. 9B to 9D to achieve the advantages similar to those discussed with reference to FIGS. 9B to 9D.

(B) In the eighth embodiment, the magnetic flux collecting rings 611, 612 are placed generally parallel to the magnetic yokes 31, 32 of the yoke unit 30, in a manner similar to the magnetic flux collecting rings 611, 612 shown in and discussed with reference to in FIG. 10A. Alternatively, the magnetic flux collecting rings 611, 612 may be tilted relative to the magnetic yokes 31, 32 in a manner similar to the magnetic flux collecting rings 581, 582 shown in FIG. 10B such that the distance between the magnetic flux collecting rings is increased on the central axis O side and is decreased on the magnetic sensor 41 side to achieve the advantage similar to the one discussed with reference to FIG. 10B.

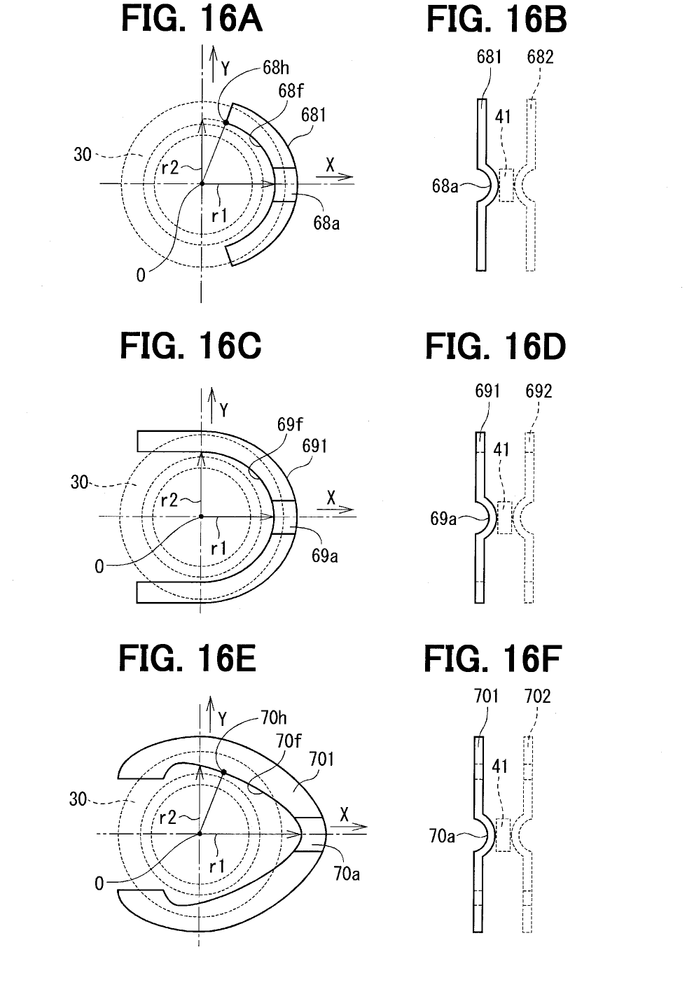

(C) FIGS. 16A to 16F show other modifications of the magnetic flux collecting rings.

Each of the magnetic flux collecting rings 681, 682 shown in FIGS. 16A and 16B is configured into a partial elliptical form, which has the size smaller than that of the semielliptical form of the magnetic flux collecting ring 611, 612 of the eighth embodiment in the circumferential direction. In this instance, the distance from the central axis O of the multipolar magnet 14 to the inner peripheral edge 68f of the magnetic flux collecting ring 681, 682 is set to be maximum in the direction X and is set to be minimum at a circumferential end point 68h of the inner peripheral edge 68f of the magnetic flux collecting ring 681, 682.

Each of the magnetic flux collecting rings 691, 692 shown in FIGS. 16C and 16D is configured into a modified form, in which two circumferential ends of the semielliptical form of the magnetic flux collecting ring 611, 612 of the eighth embodiment are further linearly extended to form two linear end portions, respectively, which are generally parallel to each other, on a side opposite from the magnetic flux collecting portion 69a in the direction X. In such a case, the distance from the central axis O of the multipolar magnet 14 to the inner peripheral edge 69f of each of the magnetic flux collecting ring 691, 692 is set to be maximum in the direction X and is set to be minimum in the direction Y.

As discussed above, the shape of the magnetic flux collecting ring, which basically has the elliptical form, can be any of the semielliptical form, the partial elliptical form having the size smaller than that of the semielliptical form or the partial elliptical form having the size larger than that of the semielliptical form.

Each of the magnetic flux collecting rings 701, 702 shown in FIGS. 16E and 16F is configured generally into an oval form (an egg-shaped form), which has an oval shaped outer peripheral edge that is elongated in the direction X. The inner peripheral edge 70f of the magnetic flux collecting ring 701, 702 is configured generally into a triangular form (a mushroom form) that is curved and has an apex on the magnetic flux collecting portion 70a side. In such a case, the distance from the central axis O of the multipolar magnet 14 to the inner peripheral edge 70f of each of the magnetic flux collecting ring 701, 702 is set to be maximum in the direction X and is set to be minimum in the direction Y.

Similar to the magnetic flux collecting portion 61a of the magnetic flux collecting ring 611, 612 of the eighth embodiment, the magnetic flux collecting portion 68a, 69a, 70a of each of the magnetic flux collecting rings 681, 682, 691, 692, 701, 702 has the arcuate shape, which is arcuately curved in the axial direction.

(D) The shape of each of the magnetic flux collecting rings of the present disclosure is not limited to the open semi-ring form. That is, each of the magnetic flux collecting rings of the present disclosure may be formed into a closed-ring form. For instance, each of the magnetic flux collecting rings 711, 712 shown in FIG. 17A is configured into a closed ring form, which has a semielliptical form on the magnetic flux collecting portion 71a side of the central axis O in the direction X and also has a semicircular form on the opposite side of the central axis O, which is opposite from the magnetic flux collecting portion 71a side in the direction X.

Each of the magnetic flux collecting rings 721, 722 shown in FIG. 17B is configured into a closed ring form and has a radial recess 72g that is recessed radially outward in the direction X in the inner peripheral edge of the magnetic flux collecting ring 721, 722. The magnetic flux collecting portion 72a is formed on the radially outer side of the radial recess 72g.

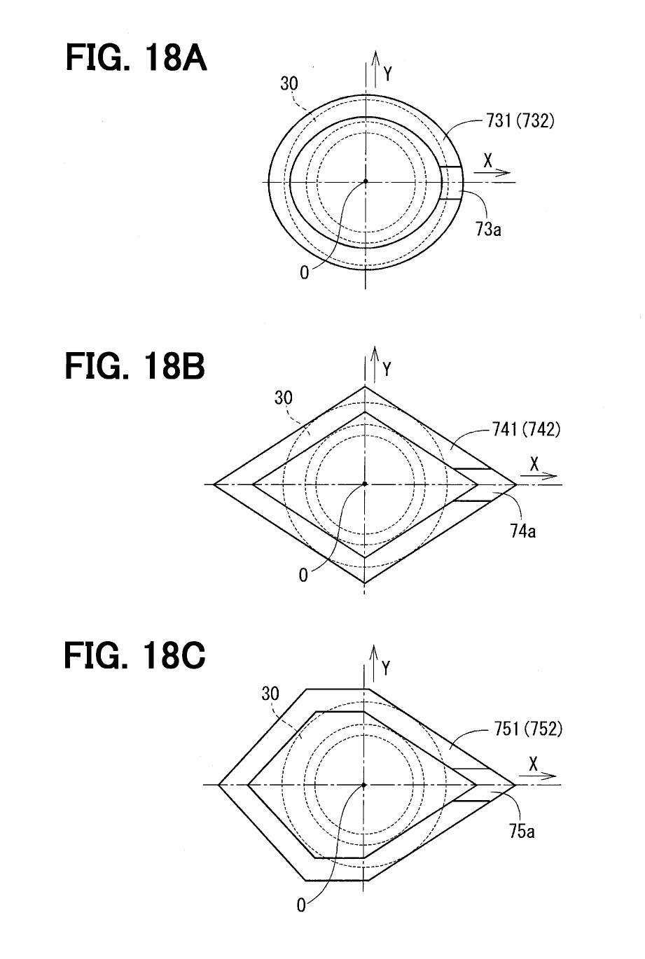

Each of the magnetic flux collecting rings 731, 732 shown in FIG. 18A is configured into a closed ring form and has a semielliptical form on each of the magnetic flux collecting portion 73a side of the central axis O in the direction X and the opposite side of the central axis O, which is opposite from the magnetic flux collecting portion 73a side in the direction X.

Each of the magnetic flux collecting rings 741, 742 shown in FIG. 18B is configured into a closed ring form and has a triangular form on each of the magnetic flux collecting portion 74a side of the central axis O in the direction X and the opposite side of the central axis O, which is opposite from the magnetic flux collecting portion 74a side in the direction X.

Each of the magnetic flux collecting rings 751, 752 shown in FIG. 18C is configured into a closed ring form and has a triangular form on the magnetic flux collecting portion 75a side of the central axis O in the direction X and a polygonal form on the opposite side of the central axis O, which is opposite from the magnetic flux collecting portion 75a side in the direction X.

Furthermore, any one or more of the components of one the above embodiments and modifications thereof may be combined with the any one or more of the components of another one or more of the above embodiments and modifications thereof within the scope and spirit of the present disclosure.

Additional advantages and modifications will readily occur to those skilled in the art. The present disclosure in its broader terms is therefore not limited to the specific details, representative apparatus, and illustrative examples shown and described.

What is claimed is:

1. A torque sensor comprising:
a torsion bar that coaxially couples between a first shaft and a second shaft and converts a torque exerted between the first shaft and the second shaft into a torsional displacement in the torsion bar;
a multipolar magnet that is fixed to one of the first shaft and one end portion of the torsion bar;
first and second magnetic yokes that are placed radially outward of the multipolar magnet and is fixed to one of the second shaft and the other end portion of the torsion bar, which is opposite from the one end portion of the torsion bar in an axial direction, wherein the first and second magnetic yokes are opposed to each other in the axial direction while a gap is interposed between the first and second magnetic yokes in the axial direction, and the first and second magnetic yokes form a magnetic circuit in a magnetic field generated by the multipolar magnet;
first and second magnetic flux collecting bodies, each of which has an opening that opens in a direction perpendicular to the axial direction and is installed into a corresponding position axially located between the first and second magnetic yokes from one radial side of the first and second magnetic yokes, wherein the first and second magnetic flux collecting bodies collect a magnetic flux from the first and second magnetic yokes; and
a magnetic sensor that senses a strength of a magnetic field between the first and second magnetic flux collecting bodies, wherein the first and second magnetic flux collecting bodies at least partially overlap with the first and second magnetic yokes in a view taken in the axial direction.

2. The torque sensor according to claim 1, wherein:
the first and second magnetic yokes are integrally resin molded to form an integrated yoke member, which is configured into a tubular form; and
a groove is formed in an outer peripheral wall of the integrated yoke member to at least partially receive the first and second magnetic flux collecting bodies.

3. The torque sensor according to claim 1, wherein:
the first and second magnetic flux collecting bodies are formed as first and second magnetic flux collecting rings, each of which extend over at least two of a plurality of magnetic poles of the multipolar magnet.

4. The torque sensor according to claim 3, wherein each of the first and second magnetic flux collecting bodies are configured into a semicircular form.

5. The torque sensor according to claim 1, wherein:
each of the first and second magnetic flux collecting bodies includes a magnetic flux collecting portion;
the magnetic flux collecting portions of the first and second magnetic flux collecting bodies are closer to each other in the axial direction in comparison to the rest of each of the first and second magnetic flux collecting bodies; and
the magnetic sensor is placed between the magnetic flux collecting portions of the first and second magnetic flux collecting bodies.

6. A torque sensor comprising:
a torsion bar that coaxially couples between a first shaft and a second shaft and converts a torque exerted between the first shaft and the second shaft into a torsional displacement in the torsion bar;
a multipolar magnet that is fixed to one of the first shaft and one end portion of the torsion bar;
first and second magnetic yokes that are placed radially outward of the multipolar magnet and is fixed to one of the second shaft and the other end portion of the torsion bar, which is opposite from the one end portion of the torsion bar in an axial direction, wherein the first and second magnetic yokes are opposed to each other in the axial direction while a gap is interposed between the first and second magnetic yokes in the axial direction, and the first and second magnetic yokes form a magnetic circuit in a magnetic field generated by the multipolar magnet;
first and second magnetic flux collecting bodies, which are placed between the first and second magnetic yokes in the axial direction and at least partially overlap with the first and second magnetic yokes in an axial view taken in the axial direction, wherein the first and second magnetic flux collecting bodies collect a magnetic flux from the first and second magnetic yokes; and
a magnetic sensor that senses a strength of a magnetic field between the first and second magnetic flux collecting bodies, wherein:
each of the first and second magnetic flux collecting bodies has an inner peripheral edge on a radially inner side thereof where the multipolar magnet is placed, and a distance from a central axis of the multipolar magnet to the inner peripheral edge of each of the first and second magnetic flux collecting bodies is set to be maximum in a predetermined radial direction along an imaginary line, which radially connects between the central axis and the magnetic sensor.

7. The torque sensor according to claim 6, wherein:
the predetermined radial direction is a first radial direction;
the distance from the central axis of the multipolar magnet to the inner peripheral edge of each of the first and second magnetic flux collecting bodies is set to be minimum along the inner peripheral edge in a second radial direction, which is perpendicular to the first radial direction.

8. The torque sensor according to claim 7, wherein the distance from the central axis of the multipolar magnet to the inner peripheral edge of each of the first and second magnetic flux collecting bodies continuously increases from the second radial direction side to the first radial direction side along the inner peripheral edge.

9. The torque sensor according to claim 6, wherein:
a radial recess is radially outwardly recessed in the predetermined radial direction in the inner peripheral edge of each of the first and second magnetic flux collecting bodies; and
the distance from the central axis of the multipolar magnet to the inner peripheral edge of each of the first and second magnetic flux collecting bodies discontinuously increases from an adjacent part, which is circumferentially adjacent to the radial recess, to the radial recess along the inner peripheral edge.

10. The torque sensor according to claim 6, wherein each of the first and second magnetic flux collecting bodies has an opening, which opens in a direction perpendicular to the axial direction and is installed into a corresponding position axially located between the first and second magnetic yokes from one radial side of the first and second magnetic yokes.

11. The torque sensor according to claim 6, wherein:
each of the first and second magnetic flux collecting bodies includes a magnetic flux collecting portion ;
the magnetic flux collecting portions of the first and second magnetic flux collecting bodies are closer to each other in the axial direction in comparison to the rest of each of the first and second magnetic flux collecting bodies; and
the magnetic sensor is placed between the magnetic flux collecting portions of the first and second magnetic flux collecting bodies.

12. The torque sensor according to claim 6, wherein:
the first and second magnetic yokes are integrally resin molded to form an integrated yoke member, which is configured into a tubular form; and
a groove is formed in an outer peripheral wall of the integrated yoke member to at least partially receive the first and second magnetic flux collecting bodies.
